(19) United States
(12) Patent Application Publication
(10) Pub. No.: US 2013/0218847 A1
(43) Pub. Date: Aug. 22, 2013

(54) FILE SERVER APPARATUS, INFORMATION SYSTEM, AND METHOD FOR CONTROLLING FILE SERVER APPARATUS

(71) Applicant: Nobuyuki Saika, Yokosuka (JP)

(72) Inventor: Nobuyuki Saika, Yokosuka (JP)

(73) Assignee: Hitachi, Ltd.,

(21) Appl. No.: 13/394,442

(22) PCT Filed: Feb. 16, 2012
(86) PCT No.: PCT/JP2012/001014

§ 371 Date: Mar. 6, 2012

(51) Int. Cl. G06F 17/30

(52) U.S. Cl. 707/692; 707/E17.01; 707/E17.002

(57) ABSTRACT

Provided is a file server apparatus 4 that processes files stored in a plurality in response to an I/O request when entity data of a plurality of files has a common portion, generates a consolidation file that holds common entity data as consolidated data; and manages each of the plurality of files as a de-duplication file that does not hold the consolidated data, and, when there is the I/O request to at least one of the plurality of files, acquires the consolidated data and processes in response to the I/O request to at least one of the plurality of files, and holds difference data generated by performing processing in response to the I/O request.

### TECHNICAL FIELD

The present invention relates to a file server apparatus, an information system, and a method for controlling the file server apparatus.

### BACKGROUND ART

PTL 1 discloses a technique for a distributed file system in which files are distributed and stored in a plurality of file servers. When data is stored redundantly, this technique eliminates data duplication while suppressing the loads on file servers. More specifically, in a storage system including a metadata server and a storage server, files stored in the storage system are classified into groups, the metadata server instructs the storage server storing the files in a distributed manner to detect duplication of files and to eliminate the duplicate data, and the storage server detects duplicate data by comparing segments of files stored therein to each other and deletes the detected duplicate data from the storage server.

PTL 2 discloses a computer system including a computer and a storage apparatus and configured to perform data de-duplication as follows. Specifically, in order to avoid load concentration to a volume under heavy load in the de-duplication, the computer determines files of a same content stored in duplicate in a plurality of volumes as consolidation target files, identifies plurality of volumes storing the consolidation target files, selects at least one volume from the plurality of volumes as a consolidation volume based on the load of the identified plurality of volumes, and deletes the consolidation target files stored in the volumes not selected.

### CITATION LIST

### Patent Literature

PTL 1: Japanese Patent Application Laid-open Publication No. 2011-65314
PTL 2: Japanese Patent Application Laid-open Publication No. 2009-80671

### SUMMARY OF INVENTION

### Technical Problem

When duplicate files are consolidated into a specific file for data de-duplication as described in PTL 2, the consolidation file, i.e., the specific file is accessed frequently due to accesses to individual files, whereby load is concentrated to a volume storing the consolidation file.

Possible solutions to such problem of load concentration to a specific file are, for example, to provide a plurality of specific files for access distribution and to store the specific file into a volume under low load or a volume achieving high performance.

However, since the contents of files vary as time passes by, such measures provide effects of the load balancing just temporarily. Therefore, in order to sustain effects of the load distribution, an appropriate measure must be taken by considering temporal changes of file contents.

In view of such problems, it is a primary object of the present invention to provide a file server apparatus, an information system and a method for controlling the file server apparatus, which are capable of stably providing effects of load balancing.

### Solution to Problem

According to one aspect of the present invention for achieving the above object, provided is a file server apparatus that processes files stored in a plurality of volumes of a storage apparatus in response to an I/O request sent from a client apparatus including, when entity data of a plurality of files has a common portion, a unit that generates a consolidation file that holds common entity data as consolidated data, and a unit that manages each of the plurality of files as a de-duplication file that does not hold the consolidated data, and, when there is the I/O request to at least one of the plurality of files, acquires the consolidated data and processes in response to the I/O request to at least one of the plurality of files, and holds difference data generated by performing processing in response to the I/O request including referring to the consolidation file, wherein whenever a predetermined timing comes, the file server apparatus determines a load balancing method according to a dependency obtained, for each of the de-duplication files, from a ratio of a data amount of the difference data of each of the de-duplication file with respect to a data amount of the consolidated data, and distributes at least any one of the consolidated data, the difference data and data of a non de-duplication file into the plurality of volumes in accordance with the determined load balancing method, the non de-duplication file being a file other than the de-duplication files and the consolidation file.

Other problems and solutions thereto disclosed by the present invention will be clarified by the following description of embodiments of the present invention with reference to the accompanying drawings.

### Advantageous Effects of Invention

The present invention provides effects of load balancing in a stable manner.

### BRIEF DESCRIPTION OF DRAWINGS

FIG. 1 is a diagram illustrating a schematic configuration of an information system 1.

FIG. 2 is a diagram illustrating functions which are provided by components of the information system 1.

FIG. 3 is a diagram illustrating a file system structure 50.

FIG. 4 is a diagram illustrating a file access method by file systems 313, 413.

FIG. 5 is a diagram illustrating an inode management table 52.

FIG. 6 is an example of the inode management table 52 managed by a metadata server apparatus 3.

FIG. 7 is a flowchart illustrating basic operations of the information system 1.

FIG. 8 is a diagram showing a de-duplication scheme.

FIG. 9 is a diagram illustrating a configuration of difference data held by a de-duplication file.

FIG. 10 is an example of the inode management table 52 of the de-duplication file.

FIG. 11 is an example of the inode management table 52 of a consolidation file.

FIG. 12 is a flowchart illustrating details of file I/O processing 5719 (updating and reference of file).

FIG. 13 is a flowchart illustrating details of file I/O processing 5719 (deletion of file).

FIG. 14 is a flowchart illustrating details of file I/O processing 5719 (duplication of file).

FIG. 15 is a diagram showing how a consolidation file is generated on the basis of a target file.

FIG. 16 is a diagram showing how the consolidation file is generated.

FIG. 17 is a diagram showing how a de-duplication file is generated.

FIG. 18 is a diagram showing how a duplication destination file is generated.

FIG. 19 is an example of a directory structure in which the consolidation file is stored.

FIG. 20 is a diagram illustrating a calculation example of the dependency.

FIG. 21 is an example of a migration destination determination table 2100.

FIG. 22 is an example of determination result (distribution destination (migration destination) of de-duplication file).

FIG. 23 is a flowchart illustrating a migration processing S2300.

FIG. 24 is a diagram illustrating a load balancing by Method A.

FIG. 25 is a diagram illustrating a load balancing by Method B.

FIG. 26 is a diagram illustrating a load balancing by Method C.

FIG. 27 is a diagram illustrating a load balancing by Method C.

FIG. 28 is a diagram illustrating how re-deduplication is performed.

FIG. 29 is a diagram illustrating a scheme to determine the necessity of the re-deduplication.

FIG. 30 is a diagram illustrating a scheme of the re-deduplication.

FIG. 31 is a flowchart illustrating a load balancing processing S3100.

FIG. 32 is an example of a load balancing method determination table 3200.

FIG. 33 is an example of a load balancing method determination table 3300.

FIG. 34 is a flowchart illustrating a load balancing processing A (S3400).

FIG. 35 is an example of a duplication management table 3500.

FIG. 36 is a flowchart illustrating a load balancing processing B (S3600).

FIG. 37 is a flowchart illustrating a load balancing processing C (S3700).

FIG. 38 is a flowchart illustrating the load balancing processing C (S3700).

FIG. 39 is a flowchart illustrating the load balancing processing C (S3700).

### DESCRIPTION OF EMBODIMENTS

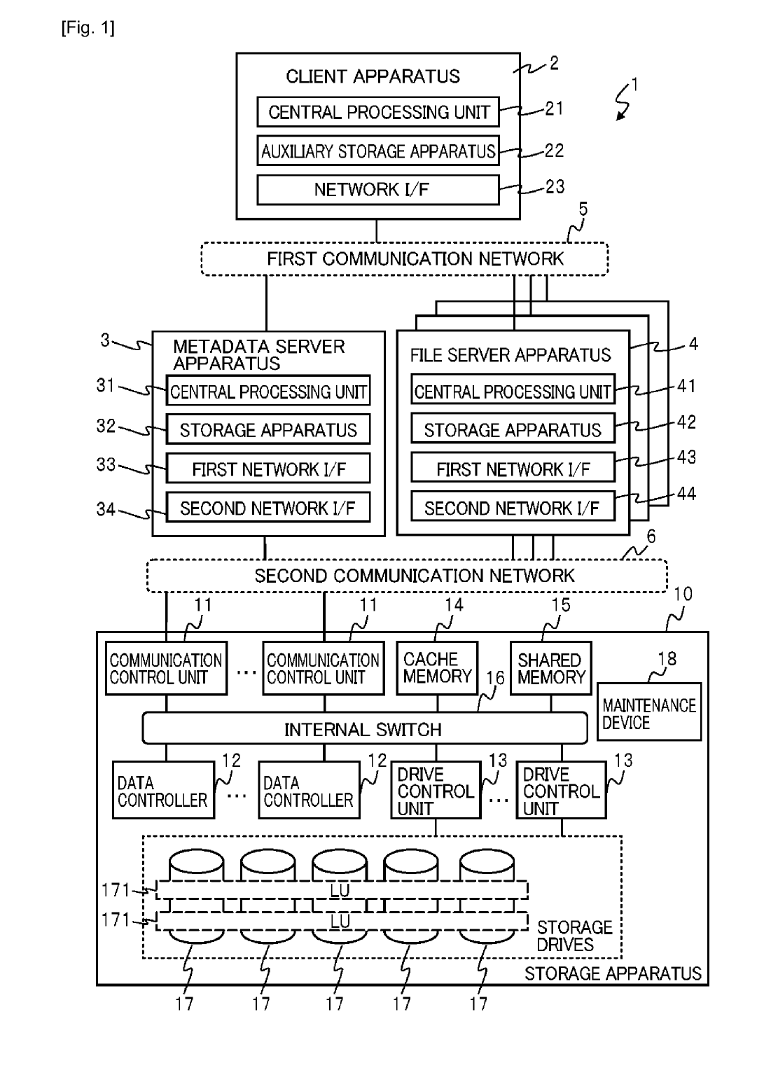

Hereinafter, embodiments of the present invention are described with reference to the accompanying drawings. FIG. 1 shows a schematic configuration of an information system 1 described as an embodiment. As shown in FIG. 1, the information system 1 includes one or more client apparatuses 2, one or more metadata server apparatuses 3, a plurality of file server apparatuses 4 and one or more storage apparatuses 10.

The client apparatus 2, the metadata server apparatus 3 and the file server apparatus 4 are coupled in a manner enabling mutual communication to each other via a first communication network 5. The metadata server apparatus 3, the file server apparatus 4 and the storage apparatus 10 are coupled to each other in a such manner enabling mutual communication other via a first communication network 6.

The first communication network 5 is, for example, LAN, WAN, internet, a lease line, a public telecommunication network, or the like. A second communication network 51 is, for example, SAN (Storage Area Network), LAN, WAN, internet, or the like.

The client apparatus 2 is, for example, an information system which provides bank's automatic cash dispenser service, internet web page browsing service, or the like, such as, for example, a personal computer, an office computer, a main frame, and the like.

The client apparatus 2 includes a central processing unit 21, an auxiliary storage apparatus 22 and a network interface (hereinafter, referred to as a network I/F 23). The central processing unit 21 comprises, for example, a CPU or a MPU. The storage apparatus 22 is a volatile or nonvolatile memory 22 (RAM, ROM, NVRAM (Non Volatile RAM)), a hard disk drive, SSD (Solid State Drive), and the like. The client apparatus 2 may further include an input device (keyboard, mouse, touch panel, or the like), and an output device (liquid crystal display, printer, or the like).

Both the metadata server apparatus 3 and the file server apparatus 4 (hereinafter, these servers may be collectively called as a server apparatus) are an information system which provides a file utilization environment to the client apparatus 2 by using a storage area provided by the storage apparatus 10, such as, for example, a personal computer, an office computer, a main frame, or the like. The metadata server apparatus 3 provides metadata described later to the client apparatus 2, and the file storage apparatus 4 provides entity data described later to the client apparatus 2.

Server apparatuses 3, 4 include central processing units 31, 41, storage devices 32, 42, first network interfaces (hereinafter, referred to as first network I/F 33, 43), and second network interfaces (hereinafter, referred to as second I/F 34, 44).

Central processing units 31, 41 are configured by using, for example, CPU or MPU. Storage devices 32, 42 are, for example, volatile or nonvolatile memory 22 (RAM, ROM, NVRAM), a hard disk drive, SSD, or the like. First network I/F 33, 43 is, for example, NIC (Network Interface Card), HBA (Host Bus Adaptor), or the like.

The storage apparatus 10 provides a data storage area to server apparatuses 3, 4. The storage apparatus 10 is, for example, a disk array device.

The storage apparatus 10 includes one or more communication control units 11, one or more data controllers 12, one or more drive control units 13, a cache memory 14, a shared memory 15, a maintenance device 18, and one or more storage drives 17. The communication control unit 11, the data controller 12, the drive control unit 13, the cache memory 14 and the shared memory 15 are coupled to each other in a manner enabling mutual communication via an internal switch 16. The storage drive 17 may be accommodated in a housing separately from other components of the storage apparatus 10.

The communication control unit 11 communicates with server apparatuses 3, 4 via the first communication network 6. The first communication control unit 11 includes a central processing unit, a memory and a network interface. The communication control unit 11 controls, for example, communication between server apparatuses 3, 4 performed according to a communication protocol and I/O request (data write request and data read request) received from server apparatuses 3, 4.

The drive control unit 13 communicates with the storage drive 17. The drive control unit 13 includes a central processing unit, a memory and a network interface. The drive control unit 13 performs, for example, reading of data stored in the storage drive 17, transfer of the read data to the cache memory 14, and transfer of data stored in the cache memory 14 to the storage drive 17.

The data controller 12 mediates data transfer among the communication control unit 11, the drive control unit 13 and the cache memory 14. The data controller 12 includes a central processing unit, a data transfer device such as DMA (Direct Memory Access), a memory and a network interface.

The data controller 12 performs, for example, delivery of data (data read from the storage drive 17 and data written into the storage drive 17) between the communication unit 11 and the drive control part 12, performed via the cache memory 14, staging (read of data from the storage drive 17) of data stored in the cache memory 14, and de-staging (writing of data into the storage drive 17).

The cache memory 14 temporarily stores, for example, data to be written into the storage drive 17 and data read from the storage drive 17 and sent to server apparatuses 3, 4. The cache memory 14 is configured by using, for example, a RAM.

The shared memory 14 stores, for example, programs and data used by the communication control unit 11, the drive control unit 13, and the data controller 12. The shared memory 15 is configured by using, for example, a storage element such as a RAM, ROM, NVRAM, and the like.

The maintenance device 18 performs setting, control, status monitoring or the like of components of the storage apparatus 10. The maintenance device 18 is an information device including a central processing unit, a memory, an auxiliary storage device, an input device, a display device, a network interface, and the like.

The maintenance device 18 communicates with components of the storage apparatus 10 via a communication means such as LAN from time to time to perform acquisition of information (configuration information, various setting information, usage information, and the like) relating to the storage apparatus 10, and setting, control, maintenance and the like of the storage apparatus 10.

The maintenance device 18 may be, in some cases, communicatively coupled with an information apparatus (herein referred to as the management apparatus) provided outside the storage apparatus 10 via a communication means such as a LAN. The management apparatus provides the user and operator with an interface (such as GUI (Graphical User Interface), CLI (Command Line Interface), and the like) for setting, control, maintenance, and the like (including software introduction and updating) of the storage apparatus 10.

The storage drive 17 is, for example, a hard disk drive (such as SAS (Serial Attached SCSI), SATA (Serial ATA), FC (Fibre Channel), PATA (Parallel ATA), SCSI (Small Computer System Interface), and the like) and a semiconductor storage device (SSD), or the like.

The storage apparatus 10 provides a storage location of data to server apparatuses 3, 4 on the basis of a logical storage area (hereinafter, alternatively referred to as LU171 (LU: Logical Unit) provided by controlling the storage drive 17 by a RAID (Redundant Arrays of Inexpensive (or Independent) Disks) method (for example, RAID 0 to 6). The logical storage area is provided, for example, as a storage area of a RAID group (alternatively referred to as a parity group).

The storage apparatus 10, when receiving an I/O request sent from server apparatuses 3, 4, operates, for example, as follows:

For example, when the storage apparatus 10 receives, for example, a data write request from server apparatuses 3, 4, the communication control unit 11 notifies the reception thereof to the data controller 12. Upon receiving the notification, the data controller 12 generates a drive write request based on the above data write request, sends the drive write request to the drive control unit 13 and stores the write data into the cache memory 14 as well. When the data controller 12 stores the write data into the cache memory 14, the communication control unit 11 sends a completion report to server apparatuses 3, 4.

Upon receiving the drive write request from the data controller 12, the drive control unit 13 registers the received drive write request to a write process queue. Then, the drive control unit 13 reads the drive write request from the write process queue from time to time, reads write data specified in the read drive write request from the cache memory 14, and writes the read write data into the storage drive 17.

When the storage apparatus 10 receives, for example, a data read request from server apparatuses 3, 4, the communication control unit 11 notifies the reception thereof to the drive control unit 13. Upon receiving the notification, the drive control unit 13 reads data specified in the data read request (for example, data specified by LBA (Logical Block Address)) from the storage drive 17. If read data has already been read out to the cache memory 14, reading of data from the storage drive 17 may be omitted.

The data controller 12 reads data read by the drive control unit 13 from the cache memory 14 and transfers the read data to the communication control unit 11. Upon receiving the read data sent from the data controller 12, the communication control unit 11 transfers the read data to server apparatuses 3, 4.

<Description of Functions>

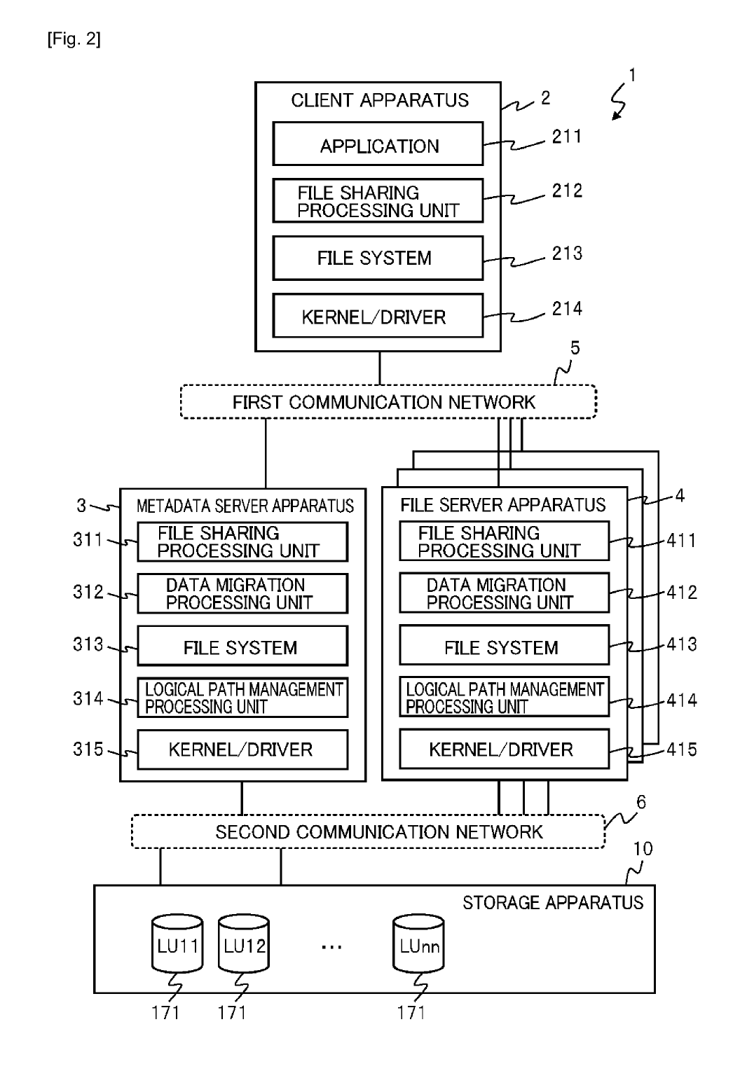

FIG. 2 shows functions provided with components of the information system 1. These functions are implemented when a central processing unit of each of the components reads and executes a program stored in the storage device or the auxiliary storage device, or by a hardware provided in each of the components.

The client apparatus 2 includes an application 211, a file sharing processing unit 212, a file system 213, and a kernel/driver 214. The application 211 is implemented by a program which implements information processing service in the client apparatus 2. The application 211 provides, for example, functions relating to a bank's automatic cash dispenser service or internet web page browsing service.

The file sharing processing unit 212 provides, in cooperation with file sharing processing units 311, 411 of server apparatuses 3, 4, a file sharing environment to the application 211 between server apparatuses 3, 4. The file sharing processing units 311, 411 will be described later. The file sharing processing unit 311 is implemented by using, for example, such as NFS (Network File System), CIFS (Common Internet File System), AFS (Andrew File System), or the like.

The file system 213 implements a file utilization environment on file basis or directory basis. The file system 213 is implemented by using, for example, FAT (File Allocation Table), NTFS, HFS (Hierarchical File System), ext2 (second extended file system), ext3 (third extended file system), ext4 (fourth extended file system), UDF (Universal Disk Format), HPFS (High Performance File system), JFS (Journaled File System), UFS (Unix File System), VTOC (Volume Table Of Contents), XFS, or the like.

The kernel/driver 214 is implemented, for example, by executing a kernel module or a driver module of an operating system. The kernel module includes, for example, programs for implementing process controls in the client apparatus 2 (execution management, scheduling, management of storage areas utilized by processes, handling with respect to interrupt requests, and the like). The driver module includes, for example, programs for implementing control of hardware and peripheral devices provided with the client apparatus 2.

As shown in FIG. 2, server apparatuses 3,4 include file sharing processing units 311, 411, data migration processing units 312, 412, file systems 313, 413, logical path management processing units 314, 414, and kernels/drivers 315, 415.

File sharing processing units 311, 411 provide, in cooperation with file sharing processing units 311, 411 of other server apparatuses 3, 4 or a file sharing processing unit 212 of the client apparatus 2, a file sharing environment between server apparatuses 3, 4 to the client apparatus 2.

The data migration processing units 312, 412 perform data migration processing between file server apparatuses 4. Details of the data migration processing performed between file server apparatuses 4 are described later.

File systems 313, 413 implement a data utilization environment on file basis or directory basis to the client apparatus 2. File systems 313, 413 are implemented, for example, by using FAT, NTFS, HFS, ext2, ext3, ext4, UDF, HPFS, JFS, UFS, VTOC, XFS, or the like.

Logical path management processing units 314, 414 manage paths (hereinafter, referred to as a logical path) of data including an I/O request and a response thereof generated when the client apparatus 2 accesses to LU 171. Logical path management processing units 314, 414 also serve as a load balancer which distributes I/O requests to logical paths so as to balance the load applied to logical paths.

Individual logical paths are identified, for example, with a combination of at least two selected from a group consisting of a communication port of first network I/F 33, 43 of server apparatuses 3, 4, a communication port of second network I/F 34, 44 of server apparatuses 3, 4, a communication port of a communication device (router, switching hub, or the like) configuring the first communication network 6, a communication port of the communication control unit 11 of the storage apparatus 10, and LU 171 at an access destination.

Logical path management processing units 314, 414 perform, for example, load balancing among logical paths by allocating an I/O request sent from the client apparatus 2 to logical paths by round-robin scheduling. Further, logical path management processing units 314, 414 perform the load balancing among logical paths by dynamically distributing I/O requests sent from the client apparatus 2 to the logical paths according to the load of the logical paths (for example, the number of I/O requests or the amount of data flowing per unit time.)

Kernel/driver 315, 415 are implemented, for example, by executing a kernel module or a driver module of an operating system. The kernel module includes, for example, programs for implementing process control in server apparatuses 3, 4. The driver module includes, for example, programs for implementing control of hardware and peripheral devices provided with server apparatuses 3, 4.

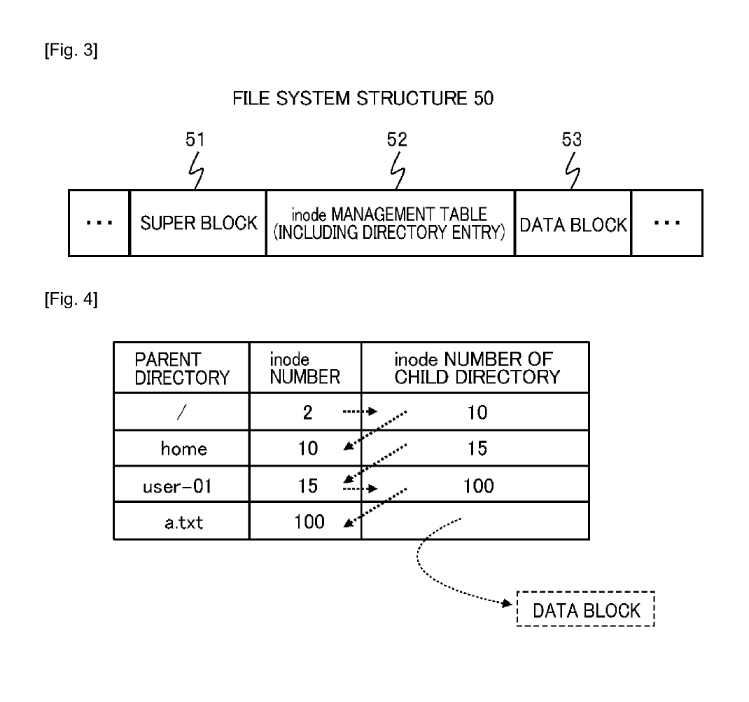

Next, file systems 313, 413 of server apparatuses 3, 4 are described. FIG. 3 shows a data structure (hereinafter, referred to as a file system structure 50) managed by the file system at LU 171. As shown in FIG. 3, the file system structure 50 includes a super block 51, an inode management table 52, and a data block 53.

Super block 51 contains settings of the number of data blocks, the size of a unit data block and the number of empty data blocks which can be handled by file systems 313, 413, and the number of inodes, the remaining number of inodes, or the like which are held by file systems 313, 413 as a whole. File systems 313, 413 manage files by associating one inode with one file (or directory).

The inode management table 52 stores an inode (or directory entry (including an inode which contains information relating to the directory only)) of a file (or a directory) stored in LU 171. The data block 53 stores entity data, which will be described later.

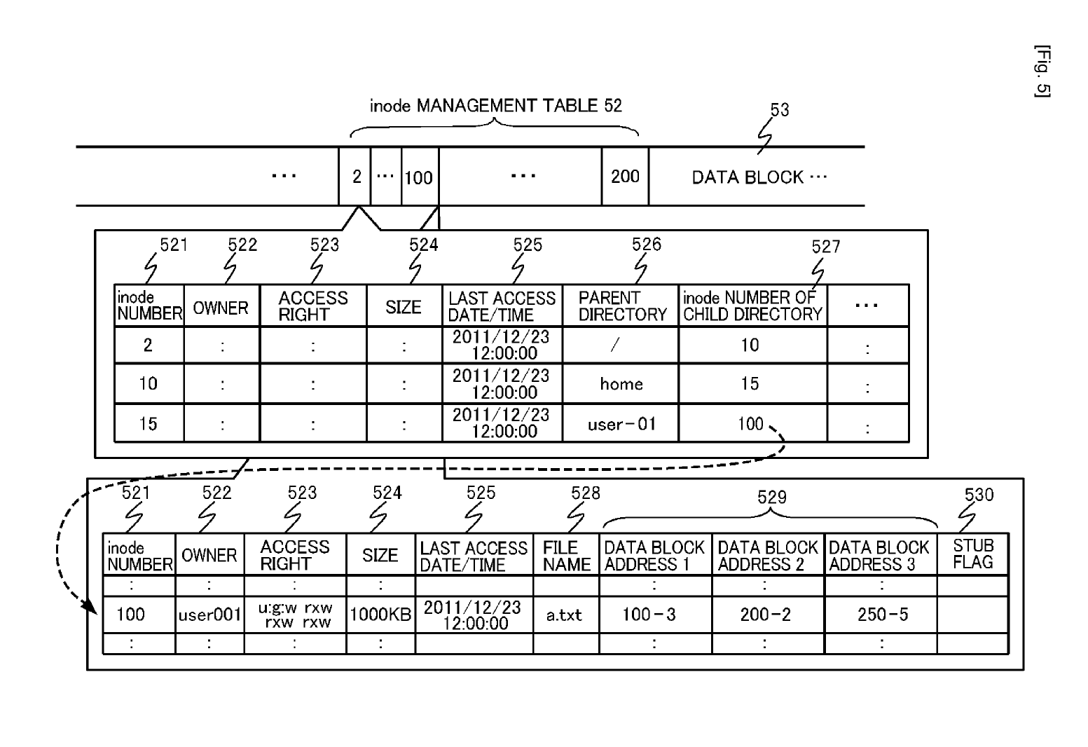

File systems 313, 413 access to a file with reference to a directory entry. For example, as shown in FIG. 4, when accessing to a file named “/home/user-01/a.txt”, file systems 313, 413 identify the address of a data block of a file at the access destination by following the inode number or the directory entry in an order indicated by arrowed lines in FIG. 4 or in the order of “2”->“10”->“15”->“100”.

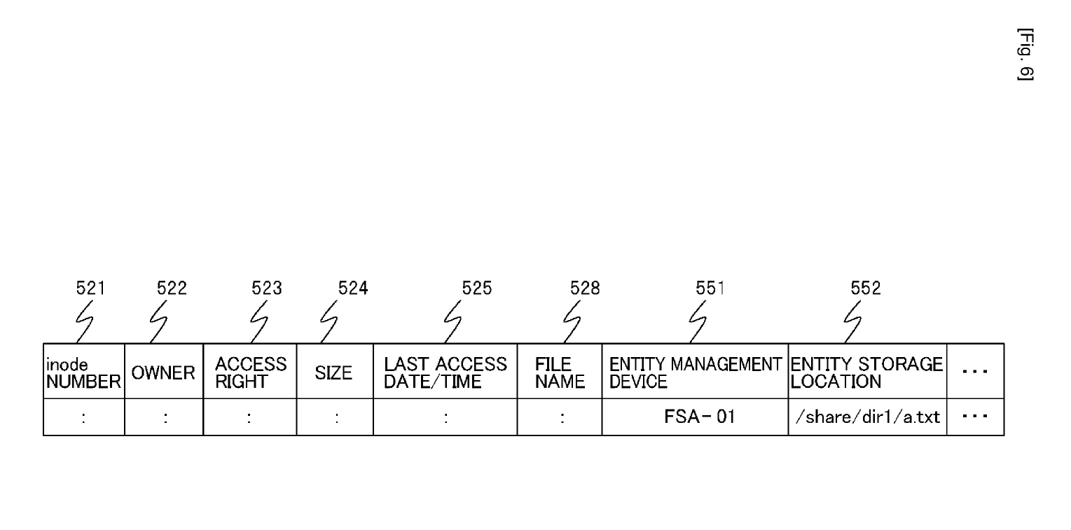

FIG. 5 shows an example of the inode management table 52. As shown in FIG. 5, individual inodes in the inode management table 52 contain an inode number 521 rep-resenting an identifier of individual inodes, an owner 522 of the file (or the directory), an access right 523 set to the file (or the directory), a file size 524 of the file (or the directory), a last access date/time 525 of the file (or the directory), a parent directory 526 of the directory which is set when the inode is a directory entry, a child director 527 of the directory which is set when the inode is a directory entry, a file name 528 of the file, an address (hereinafter, referred to as a data block address 529) of the data block in which entity (hereinafter, referred to as entity data) of the file is stored, and a stub flag 530 representing a flag indicating application or non-application of the stubbing of the file. The stubbing will be described later. In the stub flag 530, “1” is set when the file is stubbed, and “0” is set when the file is not stubbed. In the description given below, management information of a file other than the above entity data is called metadata similar to information managed in the inode management table 52.

In the information system 1, load applied to server apparatuses 3, 4 when a client apparatus 2 accesses to a file is balanced by making an apparatus (metadata server apparatus 3) providing the metadata to the client apparatus 2 and an apparatus (file server apparatus 4) providing the entity data to the client apparatus 2 independent from each other. For this reason, the inode management table 52 managed by the metadata server apparatus 3 contains information for identifying the location of the entity data corresponding to the metadata.

FIG. 6 shows an example of the inode management table 52 managed by the metadata server apparatus 3. As shown in FIG. 6, the inode management table 52 managed by the metadata server apparatus 3 contains, as information for identifying the location of the entity data, an identifier (entity management device 551) of the file server apparatus 4 responding the entity data and information (entity storage location 552) indicating the location at which the entity data is stored. Path name or file name indicating the location at which the entity data is stored is set to the entity storage location 552. Contents of the metadata managed by the metadata server apparatus 3 and contents of the metadata managed by the file server apparatus 4 are synchronized with each other from time to time.

<Basic Operations>

Next, basic operations of the information system 1 are described.

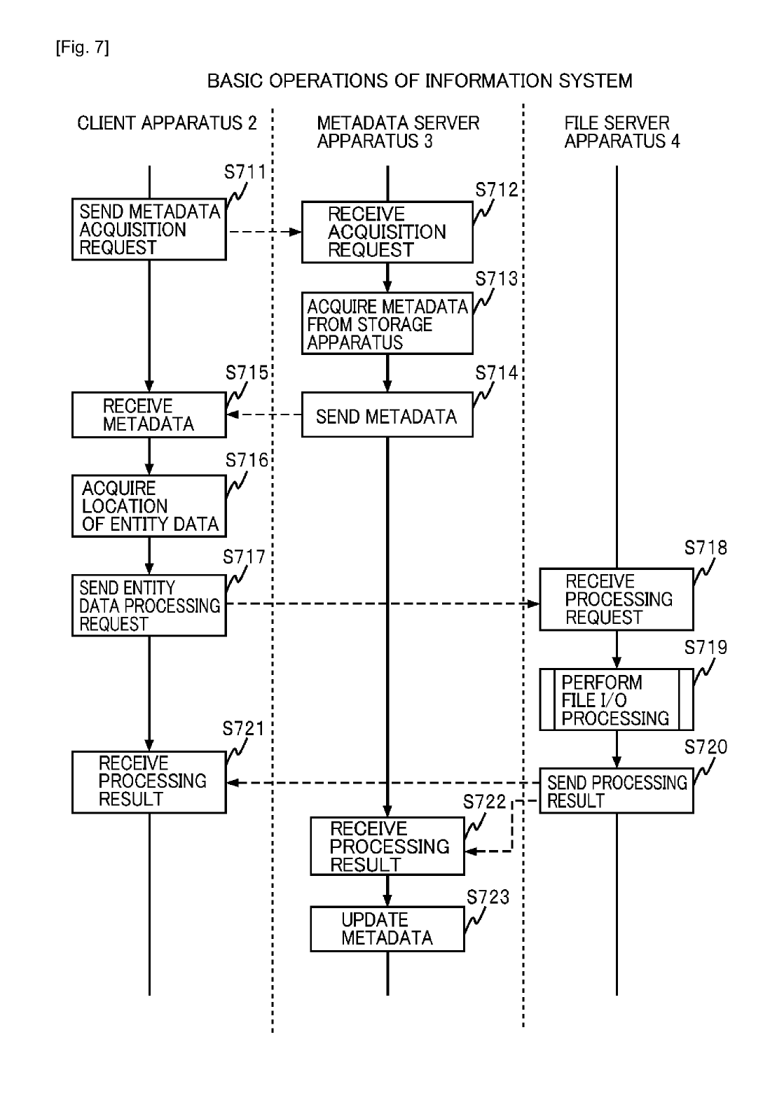

Basic operations of the information system 1 when a client apparatus 2 accesses to a file stored in the storage apparatus 10 are described with reference to a flowchart shown in FIG. 7.

When the application 211 of the client apparatus 2 activates a processing (reference, updating, duplication, deletion, or the like) with respect to a file managed by the storage apparatus 10, the client apparatus 2 sends an acquisition request of the metadata of a file to be processed (hereinafter, referred to as a target file) to the metadata server apparatus 3 (S711).

Upon receiving the above acquisition request (S712), the metadata server apparatus 3 acquires the metadata of the target file from the storage apparatus 10 (S713) and sends the acquired metadata to the client apparatus 2 (S714).

Upon receiving the metadata of the target file from the metadata server apparatus 3 (S715), the client apparatus 2 acquires the location of the entity data from the metadata (S716) and sends a processing request with respect to the entity data of the target file to a file server apparatus 4 which manages the entity data (S717).

Upon receiving the above processing request (S718), the file server apparatus 4 performs a processing (hereinafter, referred to as a file I/O processing) according to the processing request (S719) and sends a result thereof (hereinafter, referred to as a processing result) to the client apparatus 2 and the metadata server apparatus 3 (S720). Details of the file I/O processing S719 will be described later.

The processing result received by the client apparatus 2 is passed to the application 11 of the client apparatus 2 (S721).

Upon receiving the above processing result (S722), the metadata server apparatus 3 updates the metadata of the target file on the basis of the received processing result (S723).

<De-Duplication>

The file server apparatus 4 includes a scheme which eliminates duplicate holdings of common parts of the entity data when each entity data of a plurality of files has common parts. Hereinafter, the scheme is called a de-duplication function, and eliminating duplicate holdings of common parts of entity data is called a de-duplication.

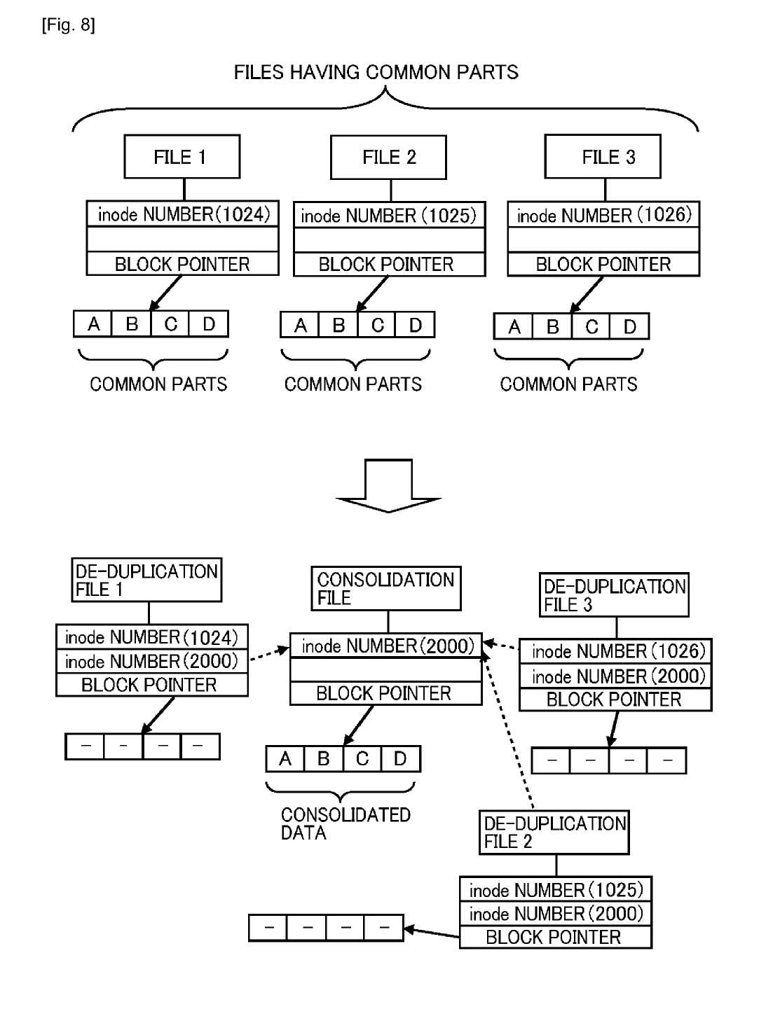

The de-duplication is performed in such a manner as described below. For example, when there are three files “File 1”, “File 2” and “File 3”, as shown in FIG. 8, each having an identical entity data, the file server apparatus 4 generates a file (hereinafter referred to as a consolidation file) having identical entity data (hereinafter referred to as consolidated data) as the entity. The file server apparatus 4 sets an inode number of the consolidation file to the metadata of the above three files. When an access requiring the entity data occurs to any one of the above three files, the file server apparatus 4 responds to the above access by acquiring the consolidated data with reference to the consolidation file.

In the case of FIG. 8, the file server apparatus 4 generates a consolidation file which holds “ABCD” as consolidated data and has an inode number 521 of “2000”, and sets the inode number “2000” of the consolidation file to metadata of each of the three files. In the description given hereinafter, a file from which consolidated data is eliminated by the de-duplication, like the above three files, is called a de-duplication file.

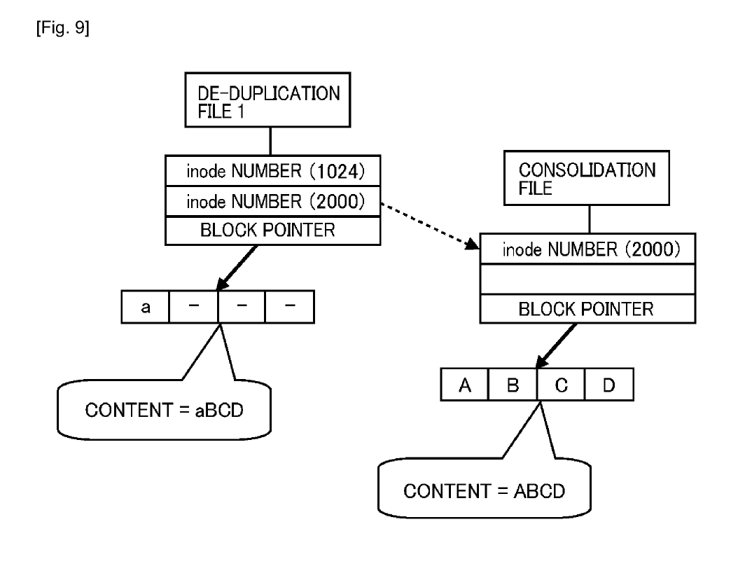

When the file I/O processing S719 described above is executed by targeting de-duplication files and thereby a change occurs in contents of the entity data as illustrated in FIG. 9, the de-duplication file holds a difference between consolidated data and entity data (hereinafter, referred to as difference data). FIG. 9 shows a case where a content of entity data of the de-duplication file 1 is changed. In this example, since a data block of a de-duplication file corresponding to “A” of consolidated data is changed to “a”, the location (block pointer) of difference data “a” is set to a data block address 529 of metadata of the de-duplication file 1.

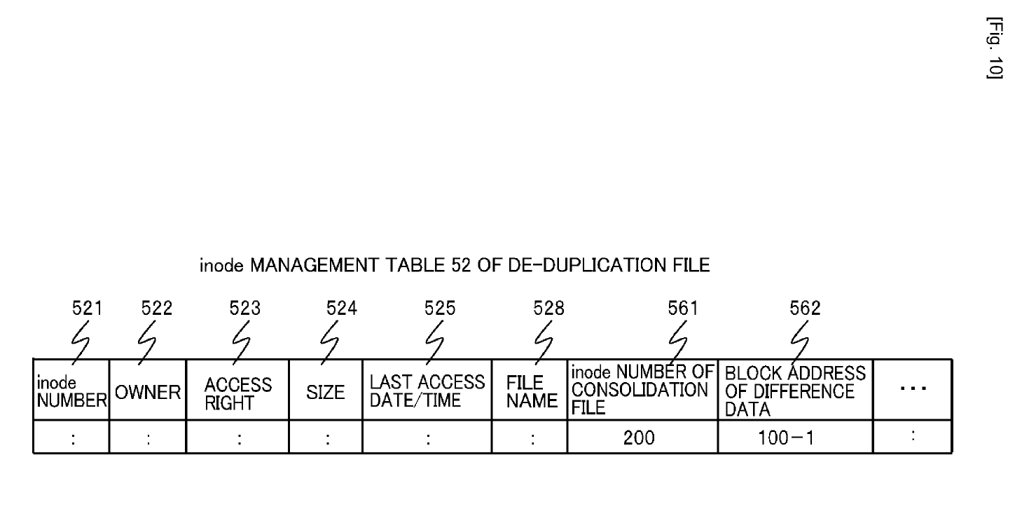

FIG. 10 shows an example of the inode management table 52 of the de-duplication file. As shown in FIG. 10, the inode management table 52 of the de-duplication file contains a consolidation file inode number 561 which is an inode number of the consolidation file, and a data block address 562 of the difference data, in addition to information shown in FIG. 5.

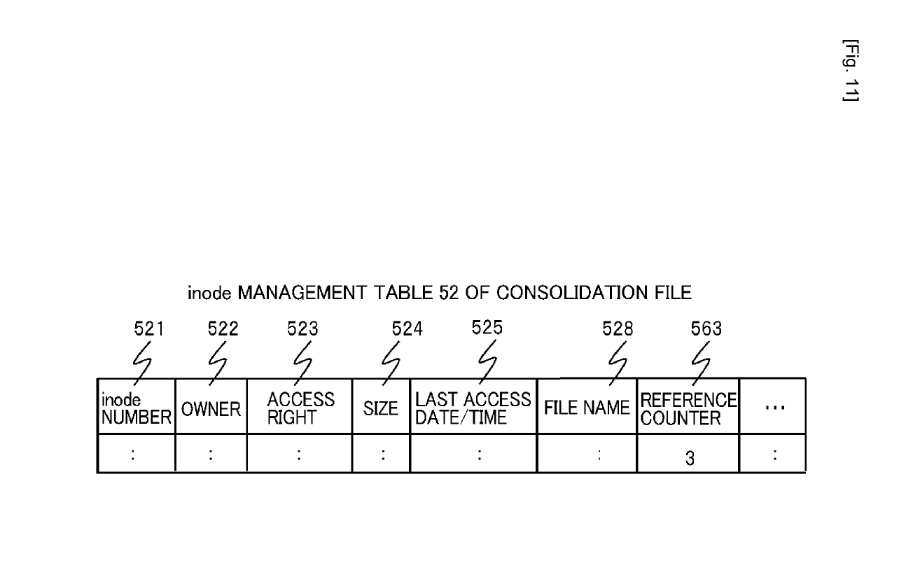

FIG. 11 shows an example of the inode management table 52 of the consolidation file. As shown in FIG. 11, the inode management file 52 of the consolidation file contains a reference counter 563 in which the number of de-duplication files referring to consolidated data of the consolidation file is set, in addition to information shown in FIG. 5.

<File I/O Processing>

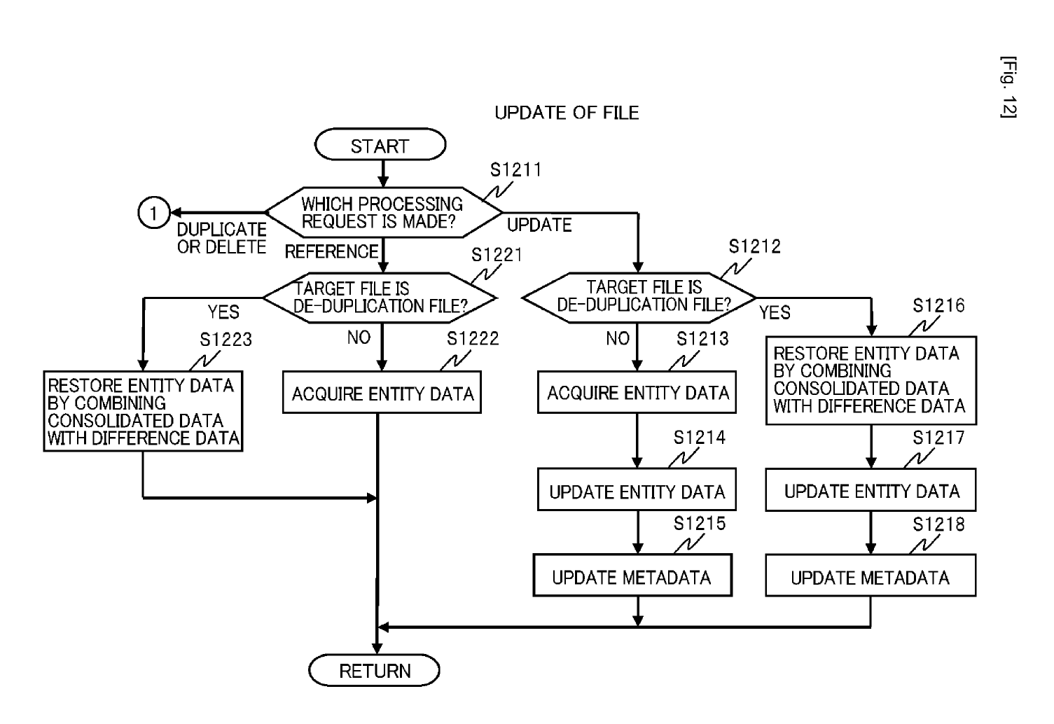

FIGS. 12 to 14 show flowcharts illustrating details of the file I/O processing S719 shown in FIG. 7. Hereinafter, the file I/O processing S719 is described with reference to these drawings.

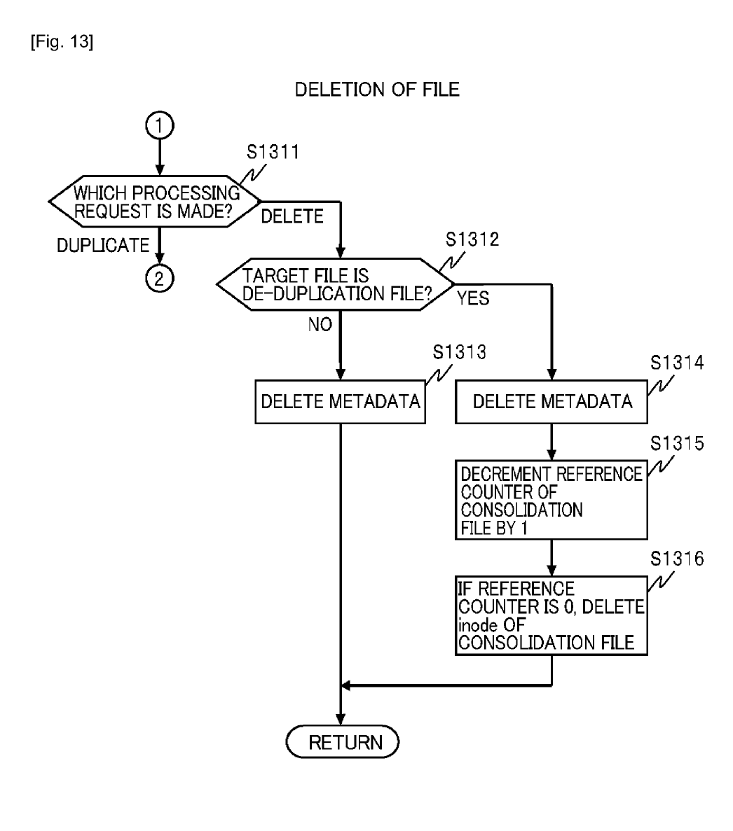

As shown in FIG. 12, first of all, the file server apparatus 4 determines the type (reference, updating, duplication, or deletion) of the processing request received at S718. If the received processing request is determined as “Update” (S1211: Update), the process proceeds to S1212. If the received processing request is determined as “Reference” (S1211: Reference), the process proceeds to S1221. If the received processing request is determined as “Duplication” or “Deletion” (S1212: Duplication, Deletion), the process proceeds to S1311 shown in FIG. 13.

If the received processing request is “Update”, the file server apparatus 4 firstly determines whether or not the target file is a de-duplication file (S1212). If the target file is determined as not a de-duplication file (S1212: NO), the process proceeds to S1213. If the target file is determined as a de-duplication file (S1212: YES), the process proceeds to S1216.

At S1213, the file server apparatus 4 acquires entity data of the target file. Then, the file server apparatus 4 performs an updating processing specified in the processing request with respect to entity data of the target file (S1214) and updates metadata of the target file to updated contents (S1215). Thereafter, the process proceeds to S720 shown in FIG. 7.

In the aforementioned processing at S723, updating of metadata same as updating of metadata at S215 is also performed in the metadata server apparatus 3, whereby contents of metadata managed by the metadata server apparatus 3 and contents of metadata managed by the file server apparatus 4 are synchronized with each other.

On the other hand, at S1216, the file server apparatus 4 acquires consolidated data of the target file and difference data of the target file and combines these data to generate entity data of the target file. Then, the file server apparatus 4 performs update processing specified in the processing request with respect to the generated entity data and stores difference data between the consolidated data of the target file and entity data of the target file after update (S1217) to update metadata of the target file to updated contents (S1218). Thereafter, the process proceeds to S720 shown in FIG. 7.

When the processing request received at S1211 is “Reference”, the file server apparatus 4 determines whether or not the target file is a de-duplication file (S1221). If the target file is not a de-duplication file (S1221: NO), the process proceeds to S1222. If the target file is a de-duplication file (S1221: YES), the process proceeds to S1223.

At S1222, the file server apparatus 4 acquires entity data of the target file. Thereafter, the process proceeds to S720.

At S1223, the file server apparatus 4 acquires consolidated data and difference data of the target file and generates entity data by combining the two data. Thereafter, the process proceeds to S720 of FIG. 7.

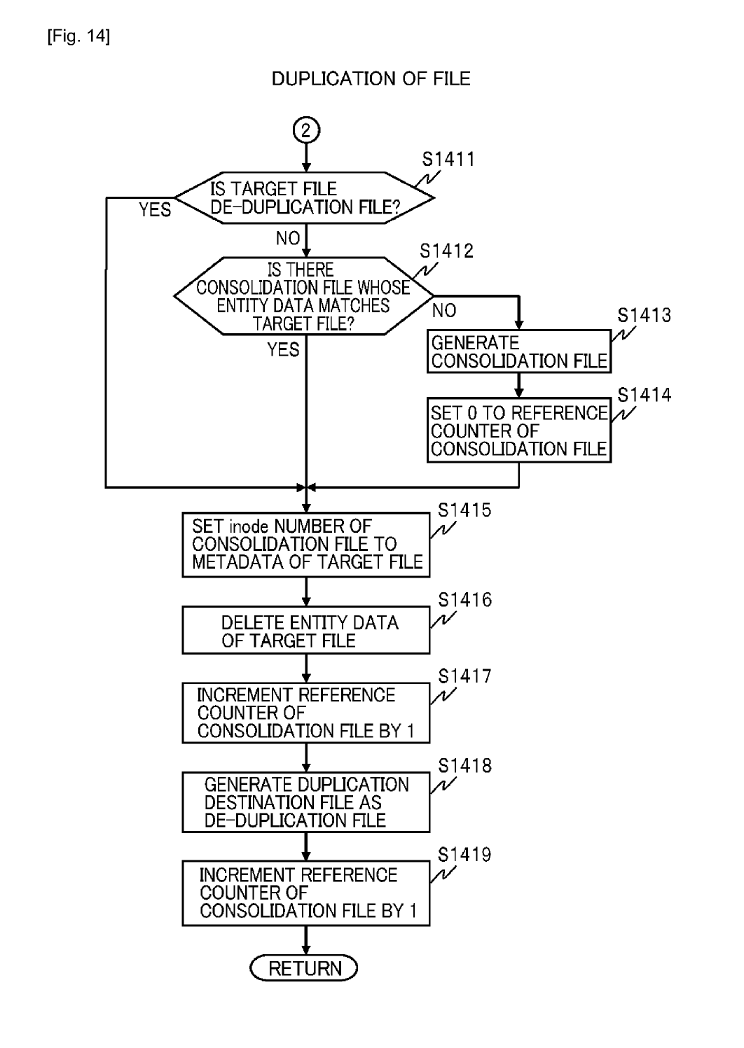

At S1311 of FIG. 13, the file server apparatus 4 determines the type (duplication or deletion) of the processing request (S1311 of FIG. 13). If the processing request is “Delete” (S1311: Delete), the process proceeds to S1312. If the processing request is “Duplicate” (S1311: Duplicate), the process proceeds to S1411 of FIG. 14.

At S1312, the file server apparatus 4 determines whether or not the target file is a de-duplication file. If the target file is not a de-duplication file (S1312: NO), the process proceeds to S1313. If the target file is a de-duplication file (S1312: YES), the process proceeds to S1314.

If the process proceeds to S1313, the file server apparatus 4 deletes metadata of the target file (for example, by disabling an inode management table 52 of the target file). Thereafter, the process proceeds to S720 of FIG. 7.

On the other hand, if the process proceeds to S1314, the file server apparatus 4 firstly deletes metadata of the target file (for example, by disabling an inode management table 52 of the target file) and decrements (−1) a value of a reference counter 563 of the consolidation file to which the target file refers (S1315). If the value of the reference counter 563 becomes 0 as a result of the subtraction, the file server apparatus 4 deletes metadata of the consolidation file (for example, by disabling the inode management table 52 of the consolidation file (S1316). Thereafter, the process proceeds to S720 of FIG. 7.

At S1411 of FIG. 14, the file server apparatus 4 determines whether or not the target file is a de-duplication file. If the target file is not a de-duplication file (S1411: NO), the process proceeds to S1412. If the target file is a de-duplication file (S1411: YES), the process proceeds to S1415.

At S1412, the file server apparatus 4 determines whether or not a consolidation file whose consolidated data matches entity data of the target file exists. If no consolidation file whose consolidated data matches entity data of the target file exists (S1412: NO), the process proceeds to S1413. If such a consolidation file exists (S1412: YES), the process proceeds to S1415.

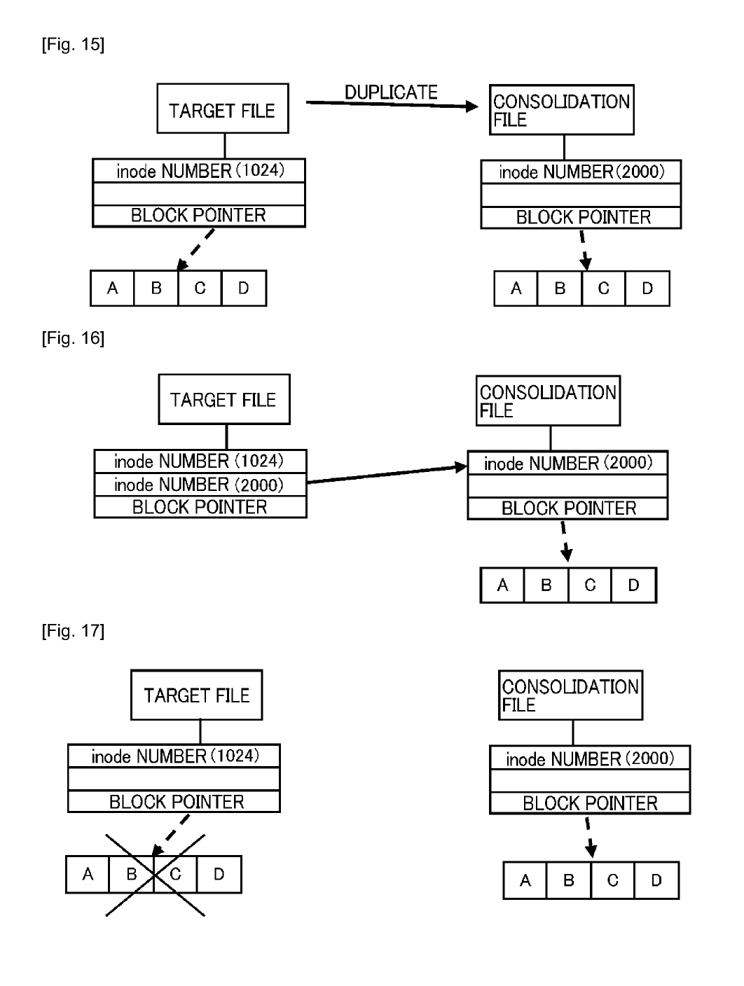

At S1413, the file server apparatus 4 newly generates a consolidation file comprising metadata of the target file as metadata (however, a new inode number 521 is acquired) and entity data of the target file as consolidated data (implementation of de-duplication). FIG. 15 shows how a consolidation file is generated on the basis of the target file. Further, the file server apparatus 4 sets “0” to a reference counter 563 of the generated consolidation file (S1414).

At S1415, the file server apparatus 4 sets the inode number of the consolidation file retrieved at S1412 or the inode number of the consolidation file generated at S1413 to metadata of the target file. FIG. 16 shows how the inode number is set.

Then, the file server apparatus 4 deletes entity data of the target file (S1416) and increments (+1) the reference counter 563 of the consolidation file (S1417). Thus, the target file turns to a de-duplication file. FIG. 17 shows this process.

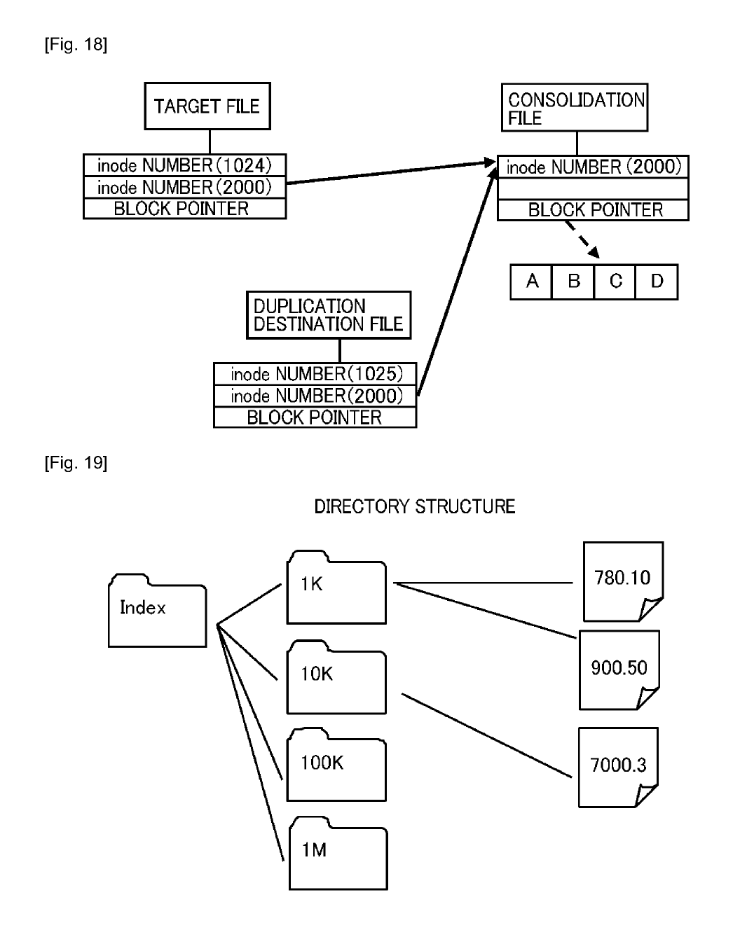

Next, the file server apparatus 4 generates a duplication destination file as the de-duplication file by generating metadata of the duplication destination file (S1418) and increments (+1) the reference counter 563 of the consolidation file (S1419). As shown in FIG. 18, the inode number of the consolidation file retrieved at S1412 or the inode number of the consolidation file generated at S1413 is set to the metadata of the duplication destination file.

In the meantime, if an appropriate directory structure for storing consolidation files is worked out, the retrieval efficiency in determining at S1412 whether or not a consolidation file having entity data matching entity data of the target file already exists can be improved.

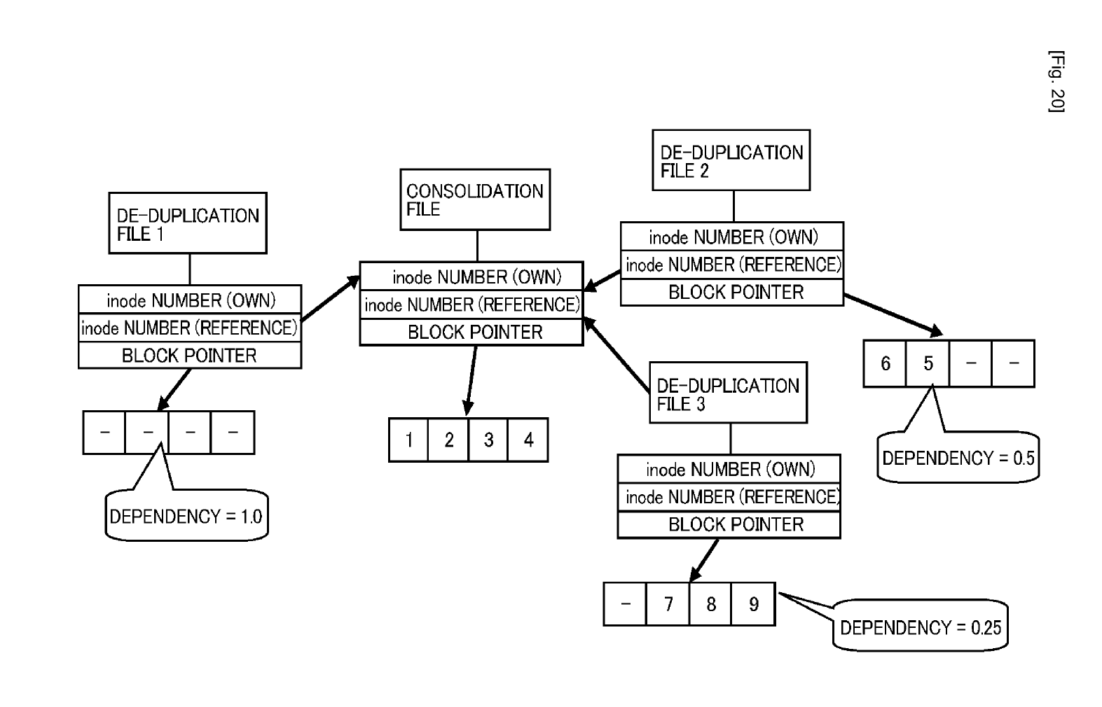

FIG. 19 shows an example that is worked out. In this example, a dedicated parent directory (parent folder) for storing the consolidation file is provided, and under the parent directory, multiple child directories (child folders) are provided per attribute (data size, inode number, or the like) of the consolidation file so as to store a consolidation file into a child director corresponding to the data size of the consolidation file.

With such configuration of the directory structure, consolidation files for comparison can be sorted out on the basis of the data size of the target file, whereby retrieval efficiency in determining at S1412 whether or not a consolidation file having entity data matching entity data of the target file already exists can be improved. Further, troubles such as loss of a consolidation file due to an operation error by a user may be prevented by setting an appropriate access right to the above dedicated parent directory.

<Function of Allocating Files Among File Server Apparatuses>

The information system 1 has a function with which a group of de-duplication files including a consolidation file of consolidated data and a group of de-duplication files referring to the consolidation file are allocated to file server apparatuses 4 according to a ratio of difference data to the consolidated data (hereinafter, referred to as a dependency). Hereinafter, this function (hereinafter, referred to as a file allocating function) is described.

FIG. 20 shows a calculation example of the above dependency. For example, “De-duplication file 1” has a dependency of “1.0 (100%)” as it refers to all four data blocks of the consolidation file. “De-duplication file 2” has a dependency of “0.5 (50%)” as it refers to two out of the four data blocks of the consolidated data. “De-duplication file 3” has a dependency of “0.25 (25%)” as it refers to only one out of the four data blocks of consolidated data. In the case of this example, a mean value (1.0+0.5+0.25/3=0.58) of the dependencies determined for de-duplication files belonging to a group of de-duplication files is set as a dependency of the consolidation file (or the de-duplication file group).

Allocation of the group of de-duplication files among file server apparatuses 4 according to a dependency thus determined is performed, for example, as follows:

Each of file server apparatuses 4 determines a dependency of the consolidation file allocated thereto, compares the determined dependency with a predetermined policy to determine file server apparatuses 4 to which the group of de-duplication files are to be allocated (destined), and sends result thereof (hereinafter, referred to as a determination result) to the metadata server apparatus 3.

Upon receiving the determination result from the file server apparatus 4, the metadata server apparatus 3 allocates (migrates) the group of de-duplication files to file server apparatuses 4 according to the determination result.

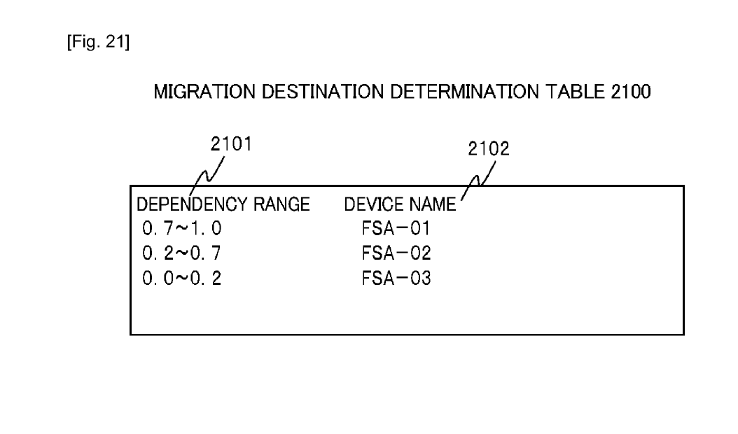

FIG. 21 is an example of the above policy (migration destination determination table 2100) managed by the file server apparatuses 4. As shown in FIG. 21, an identifier (device name 2102) of the file server apparatus 4 to which a group of de-duplication file is to be allocated is set for each dependency range (dependency range 2101) on the consolidation file (de-duplication files) in the migration destination determination table 2100.

The migration destination determination table 2100 shown in FIG. 21 designates to allocate a group of de-duplication files of a highest dependency to “FSA-01”, a group of de-duplication files of a medium dependency to “FSA-02” and a group of de-duplication files of a lowest dependency to “FSA-03”, respectively.

In the description given hereinafter, a dependency within a range of “0.7” exclusive to “1.0” inclusive is referred to as an initial stage (first range), a dependency within a range of “0.2” exclusive to “0.7” inclusive is referred to as a medium stage (second range), and a dependency range of “0.0” and “0.2”, both inclusive, is referred to as a later stage (third range). Each of the dependency ranges at initial, medium and later stages is not limited thereto. The dependency ranges may be set appropriately by a user or an operator according to the specifications or performance of the information system 1 or requirements for the information system 1.

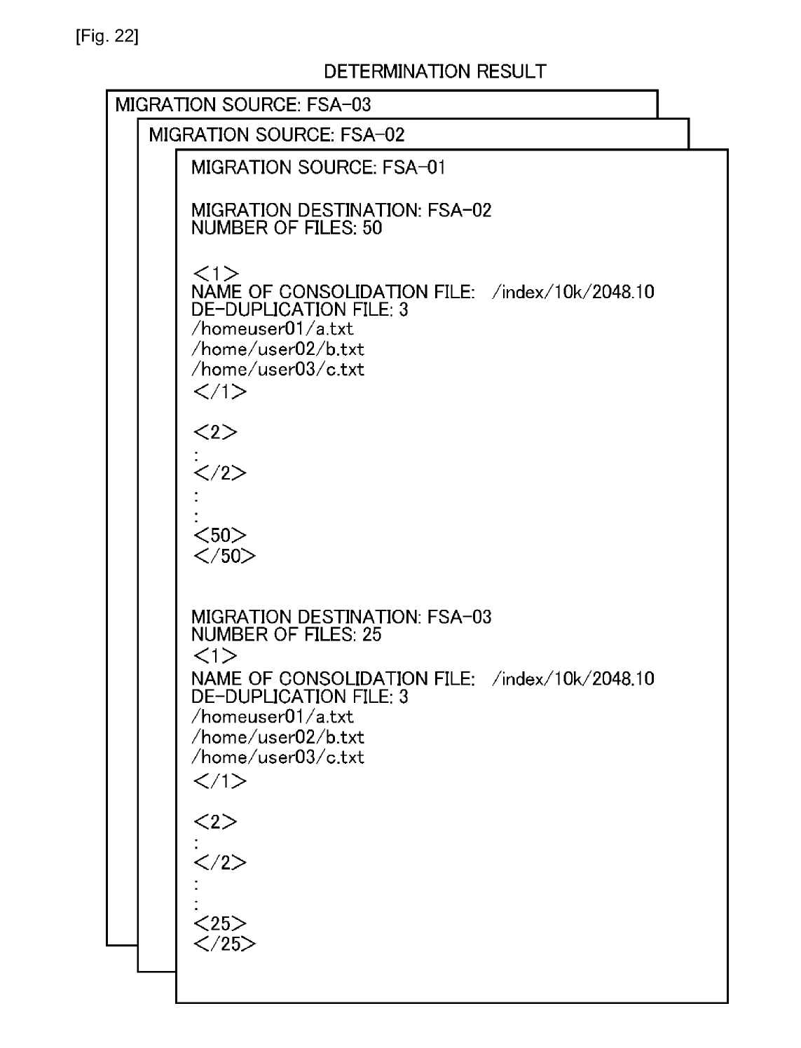

FIG. 22 shows an example of the above determination result. In this example, 50 de-duplication files of a file server apparatus 4 “FSA-02” and 25 de-duplication files of a file server apparatus 4 “FSA-03” are designated as migration targets to a file server apparatus 4 of the migration source “FSA-01”.

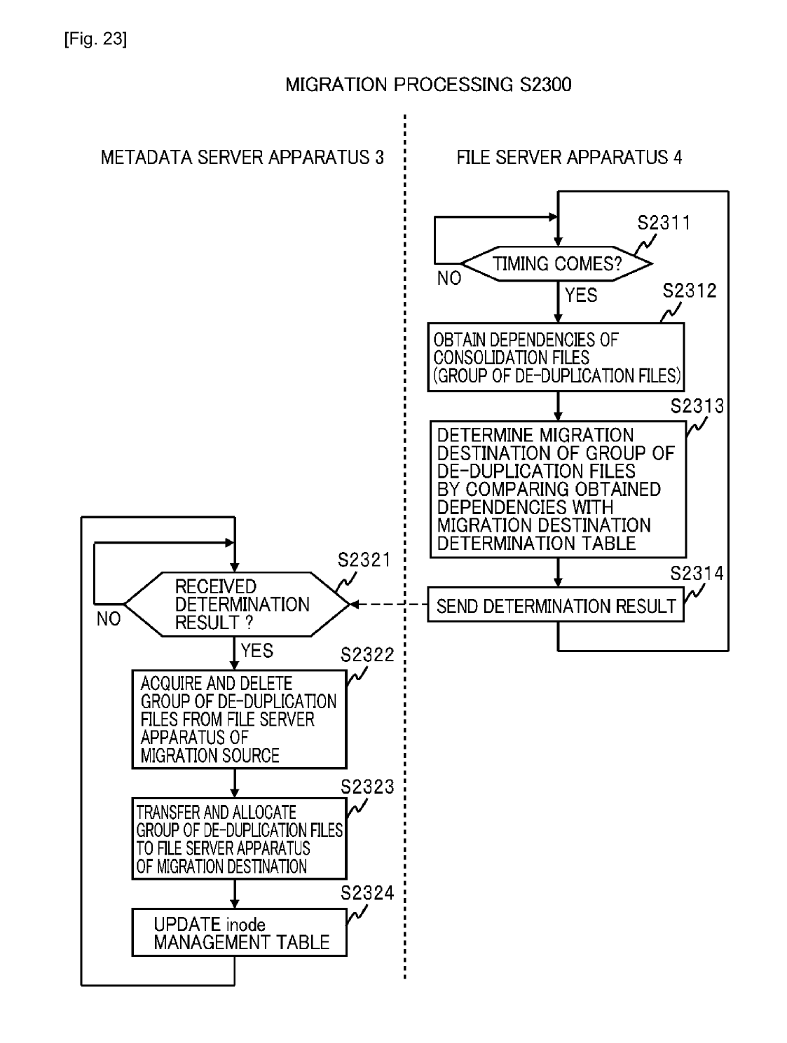

FIG. 23 is a flowchart illustrating a migration processing (hereinafter, referred to as a migration processing 2300) of the group of de-duplication files performed in the information system 1 when allocating according to a dependency. Hereinafter, the migration processing 2300 is described with reference to FIG. 23.

The file server apparatus 4 monitors in real time for the coming of a timing (periodically, at a pre-scheduled date/time, or the like) to send the above determination result to the metadata server apparatus 3 (S2311). When the timing comes (S2311: YES), the file server apparatus 4 determines the dependency (mean value of dependencies) of consolidation files (de-duplication files) allocated thereto (S2312).

Next, the file server apparatus 4 compares a determined dependency with the migration destination determination table 2100 to determine the migration destination of the group of de-duplication files allocated thereto (S2313). Then, the file server apparatus 4 sends the result (hereinafter, referred to as a determination result) to the metadata server apparatus 3 (S2314).

The metadata server apparatus 3 is in standby in real time for reception of the above determination result (S2321). Upon receiving the above determination result (S2321: YES), the metadata server apparatus 3 communicates with a file server apparatus 4 of the migration source to acquire the group of de-duplication files to be migrated and deletes those group of de-duplication files from the file server apparatus 4 of the migration source (S2322).

Next, the metadata server apparatus 3 communicates with a file server apparatus 4 of the migration destination to transfer and allocate acquired group of de-duplication files to the file server apparatus 4 of the migration destination (S2323). The metadata server apparatus 3 updates an entity management device 551 and an entity storage position 552 in an inode management table 52 of the group of de-duplication files migrated from the source to the destination (S2324).

The migration processing 2300 described above migrates the group of de-duplication files among file server apparatuses 4 via the metadata server apparatus 3, but the group of de-duplication files may also be migrated by direct communication among file server apparatuses 4.

<Load Balancing Function in File Server Apparatus>

The file server apparatus 4 has a scheme capable of performing the load balancing by appropriately allocating data of files allocated thereto into LU 171 serving as a storage area thereof. The file server apparatus 4 performs the load balancing by selecting any one of the three load balancing methods (Method A, Method B and Method C).

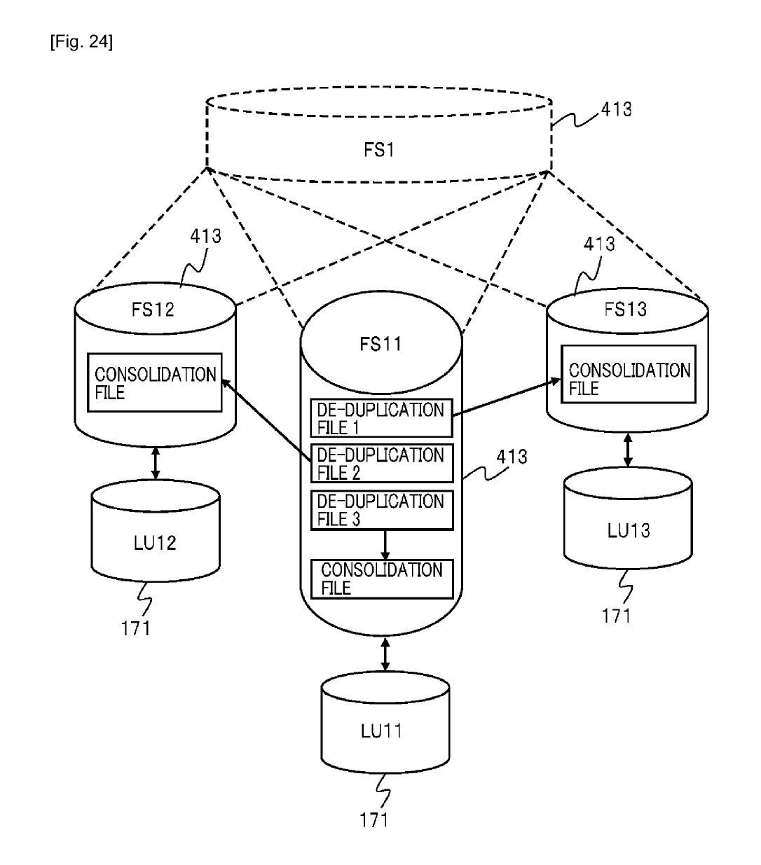

When performing the load balancing in accordance with Method A among the three load balancing methods, the file server apparatus 4 allocates a consolidation file to a plurality of LUs 171. FIG. 24 shows how the load balancing by Method A is performed. In the case of this example, consolidation files having a same content are distributed to “LU11”, “LU12” and “LU13”.

Method A is effective when mainly the group of de-duplication files of the dependency at the initial stage is allocated to the file server apparatus 4 by the file al-locating function among file server apparatuses 4. That is, when the group of de-duplication files of the dependency at the initial stage is allocated to the file server apparatus 4, access to a consolidation file takes place frequently due to access to individual de-duplication files of a group of de-duplication files of the dependency at the initial stage. Loads resulting from accesses to de-duplication files can be distributed to plurality of LUs 171 by implementing Method A which distributes a consolidation file to the plurality of LUs 171.

In FIG. 24, “FS11” is a file system 413 using “LU11” as a storage area, “FS12” is a file system 413 using “LU12” as a storage area, and “FS13” is a file system 413 using “FS13” as a storage area. “FS1” is a virtual file system 413 which controls three file systems 413 including “FS11”, “FS12” and “FS13”.

“FS1” communicates with the client apparatus 2, the metadata server apparatus 3 and other file server apparatuses 4 to serve as a contact window thereof for utilizing storage areas provided by the three file systems 413 including “FS11”, “FS12” and “FS13”.

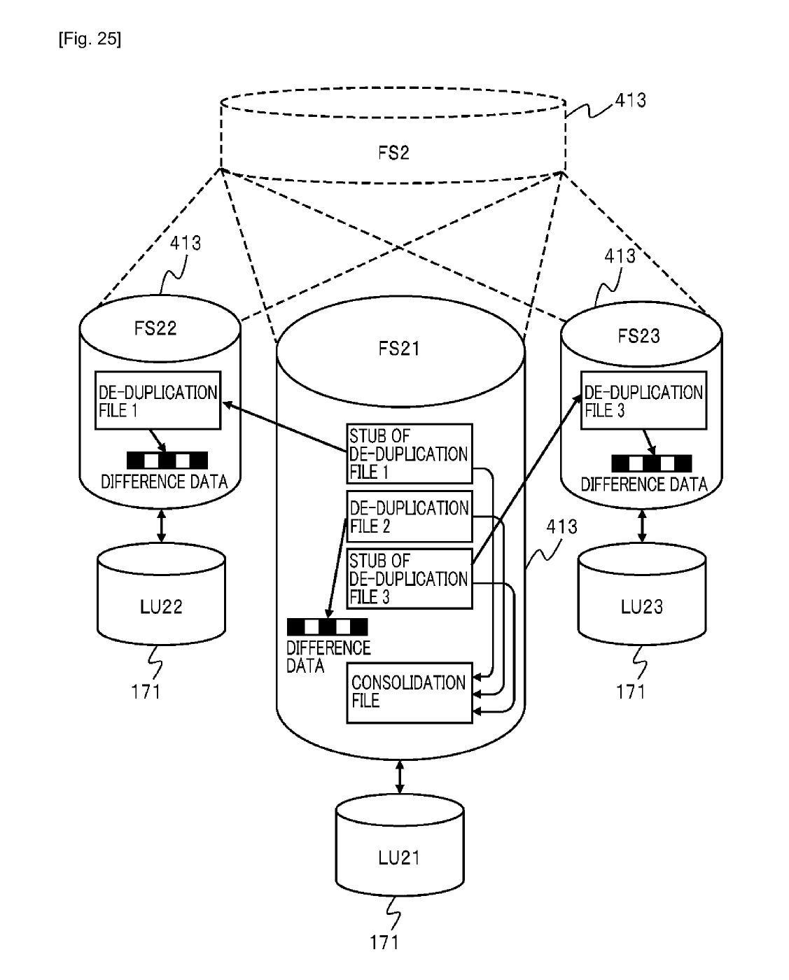

When performing the load balancing by Method B, the file server apparatus 4 distributes difference data of the de-duplication files to a plurality of LUs 171. FIG. 25 shows how the load balancing by Method B is performed. In the case of this example, difference data of “De-duplication File 1”, difference data of “De-duplication File 3” and difference data of “De-duplication File 2” are allocated to “LU22”, “LU23” and “LU21” respectively.

Method B is effective when mainly the group of de-duplication files of the dependency at the medium stage is allocated to file server apparatus 4 by the file al-locating function among file server apparatuses 4. That is, when the group of de-duplication files of the dependency at the medium stage is allocated to the file server apparatus 4, access to difference data takes place frequently due to access to de-duplication files of a group of de-duplication files of the dependency at the medium stage. Loads resulting from accesses to de-duplication files can be distributed to a plurality of LUs 171 by implementing Method B which distributes difference data to the plurality of LUs 171.

In FIG. 25, “FS21” is a file system 413 using “LU21” as a storage area, “FS22” is a file system 413 using “LU22” as a storage area, and “FS23” is a file system 413 using “LU23” as a storage area. “FS2” is a virtual file system 413 which controls three file systems 413 including “FS21”, “FS22” and “FS23”.

“FS2” communicates with the client apparatus 2, the metadata server apparatus 3 and other file server apparatuses 4 to serve as a contact window thereof for utilizing storage areas provided by the three file systems 413 including “FS21”, “FS22” and “FS23”.

In FIG. 25, “Stub” refers to metadata residing in a first file system when only entity data among data in files allocated to the first file system is allocated to a second file system (hereinafter, referred to as stubbing). A stubbed inode management table 52 contains information for identifying the location of entity data of the file. A stub flag 530 of the inode management table 52 of the stubbed file carries a setting of “1”. In FIG. 25, “De-duplication File 1” and “De-duplication File 3” are stubbed, and entity of the de-duplication file 1 and entity of the de-duplication file 2 are allocated to “F522” and “F523” respectively.

When performing the load balancing by Method C, the file server apparatus 4 stubs a file which is neither a de-duplication file nor a consolidation file (hereinafter, referred to as a non de-duplication file), among LUs 171 to which the group of de-duplication files are allocated, and allocates the entity data of non de-duplication files to another LU 171. For the group of de-duplication files of a lower dependency, the de-duplication is implemented again (hereinafter, referred to as a re-deduplication).

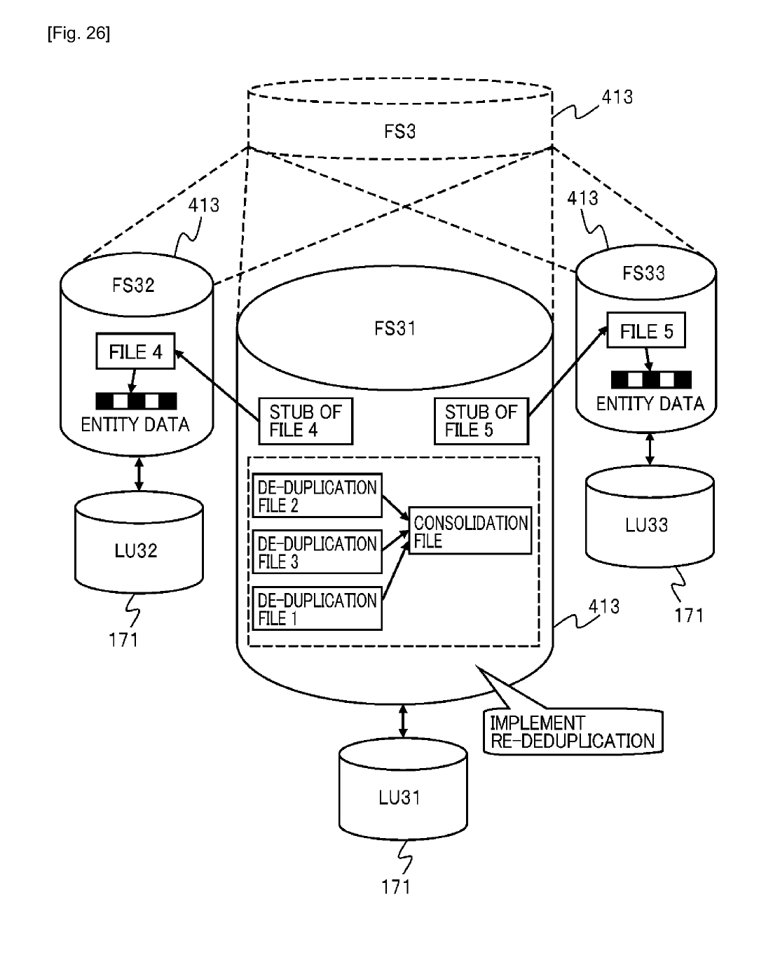

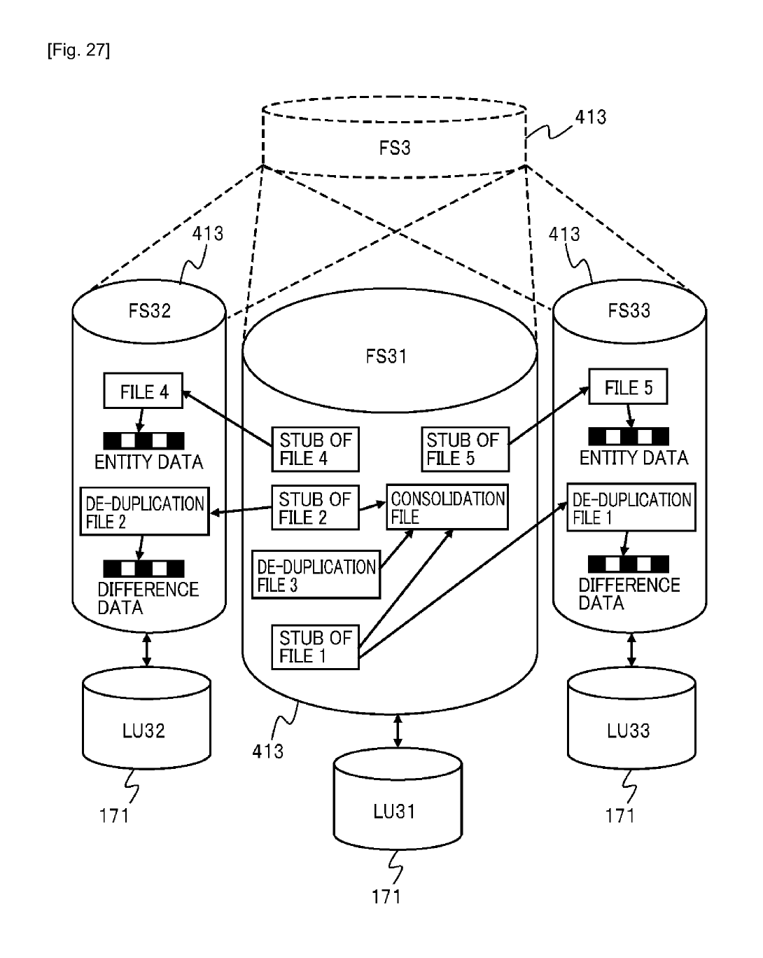

FIG. 26 shows how the load balancing by Method C is performed. In this example, a non de-duplication file “File 4” is stubbed and entity data thereof is allocated to “LU32”, while a non de-duplication file “File 5” is stubbed and entity data thereof is allocated into “LU33”. Further, a group of de-duplication files consisting of three de-duplication files allocated to “LU31” including “De-duplication File 1”, “De-duplication File 2” and “De-duplication File 3” and a consolidation file to which these de-duplication files refer to are de-duplicated again.

Method C is effective when mainly the group of de-duplication files of the dependency at the later stage is allocated to file server apparatus 4 by the above file al-locating function among file server apparatuses 4. That is, when the group of de-duplication files of the dependency at the later stage is allocated to file server apparatus 4, access to difference data takes place frequently due to access to de-duplication files of a group of de-duplication files of the dependency at the later stage. However, load to LU 171 to which a group of de-duplication files is allocated is reduced by performing Method C which stubs non de-duplication files and allocates entity data of the non de-duplication files to LU 171 different from LU 171 to which a group of de-duplication files is allocated. Further, if the dependency increases by the re-deduplication, load to LU 171 of the file server apparatus 4 is reduced by applying another load balancing method.

In FIG. 26, “FS31” is a file system 413 using “LU31” as a storage area, “FS32” is a file system 413 using “LU32” as a storage area, and “FS33” is a file system 413 using “LU33” as a storage area. “FS3” is a virtual file system 413 which controls three file systems 413 including “FS31”, “FS32” and “FS33”.

“FS3” communicates with the client apparatus 2, the metadata server apparatus 3 and other file server apparatuses 4 to serve as a contact window thereof for utilizing storage areas provided by the three file systems 413 including “FS31”, “FS32” and “FS33”.

When effect of the load balancing is not sufficient even after stubbing of non deduplication files and the re-deduplication, for example, de-duplication files may be stubbed to allocate entity data thereof to a plurality of LUs 171.

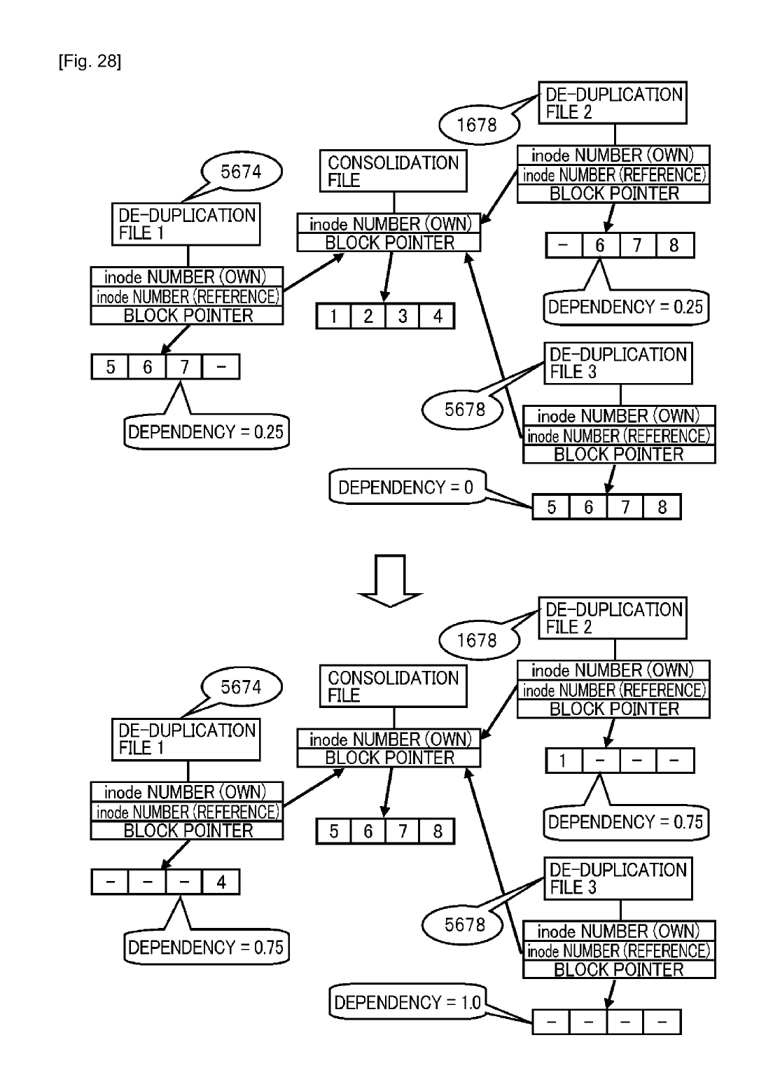

FIG. 28 is a diagram illustrating re-deduplication. FIG. 28 is a diagram illustrating the case where re-deduplication of a group of de-duplication files consisting of three deduplication files including “De-duplication File 1”, “De-duplication File 2”, and “Deduplication File 3” and a consolidation file to which those de-duplication files refer.

In FIG. 28, the upper diagram shows the status of de-duplication files not yet subjected to the re-deduplication, and the lower diagram shows the status of the deduplication files after being subjected to the re-deduplication. This example illustrates that after the re-deduplication, the dependency of “De-duplication File 1” increases from “0.25” to “0.75”, the dependency of “De-duplication File 2” increases from “0.25” to “0.75”, and the dependency of “De-duplication File 3” increases from “0.0” to “1.0”.

The file server apparatus 4, for example, determines in the following manner whether or not the re-deduplication is necessary, and performs the re-deduplication if its necessity is determined.

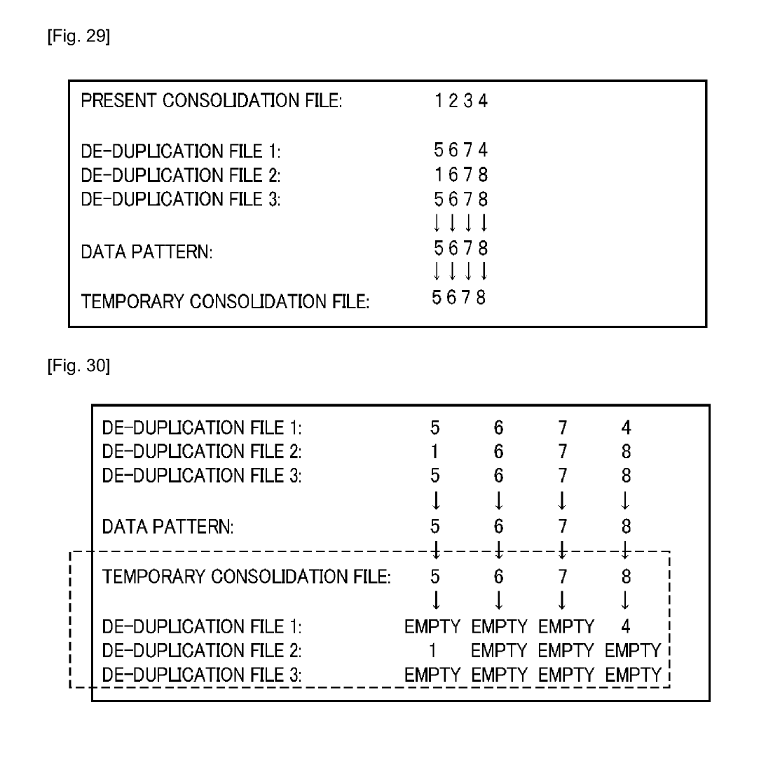

Specifically, as shown in FIG. 29, the file server apparatus 4 compares data blocks of respective de-duplication files belonging to a same group of de-duplication files one by one from the head to extract data of highest occurrence frequency (“5”, “6”, “7” and “8” in the case shown in FIG. 29), generates a data pattern in which such data is arranged in the order, and selects a de-duplication file most similar to the generated data pattern (“De-duplication File 3” in FIG. 29) as a temporary consolidation file.

Next, the file server apparatus 4 compares a total number of reference data blocks of current de-duplication files with respect to a present consolidation file (hereinafter, referred to as a present reference number) and a total number of reference data blocks of current de-duplication files with respect to a temporary consolidation file (hereinafter, referred to as a temporary reference number) with each other, and if the temporary reference number exceeds the present reference number, the file server apparatus 4 determines that re-deduplication is necessary (implementation of the re-deduplication is enabled).

Then, the file server apparatus 4 generates difference data by comparing the temporary consolidation file and de-duplication files with each other, for example, as shown in FIG. 30, and generates new de-duplication files.

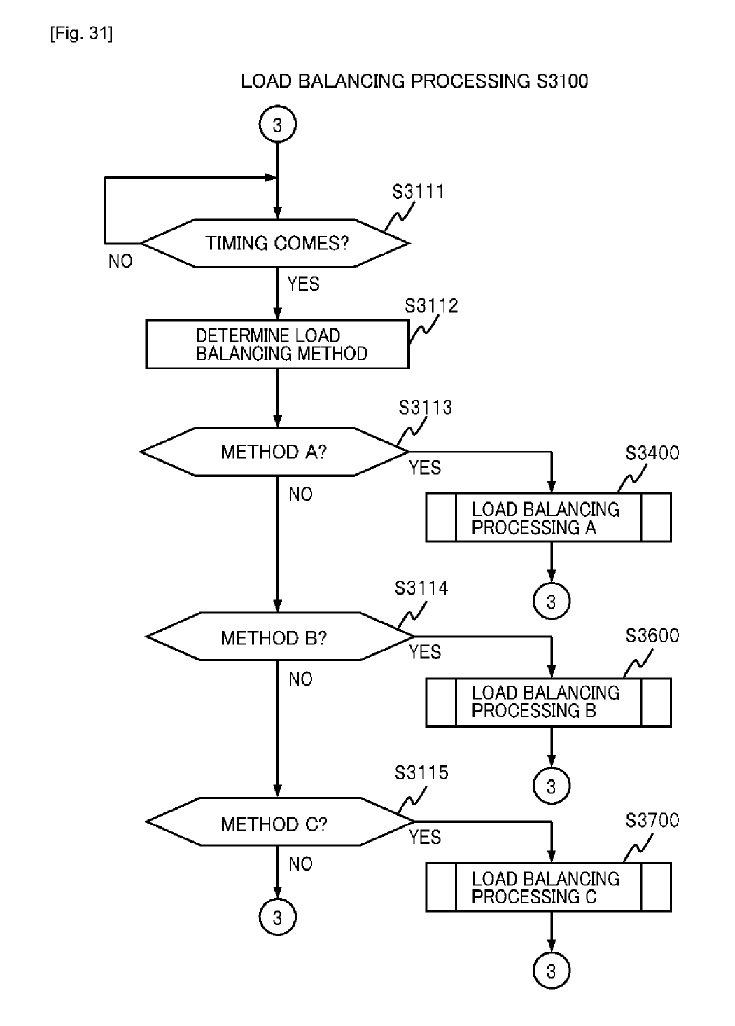

FIG. 31 is a flowchart illustrating a processing performed by the file server apparatus 4 in connection with the load balancing function described above (hereinafter, referred to as the load balancing processing S3100). Hereinafter, the load balancing processing S3100 is described.

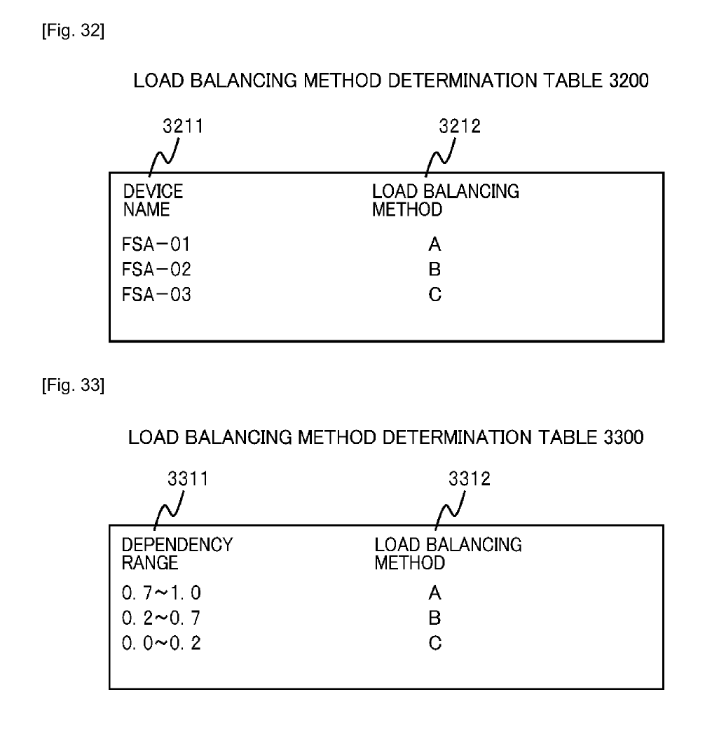

The file server apparatus 4 monitors in real time for the coming of a timing (periodically, at a pre-scheduled time, or the like) to implement the load balancing (S3111). When the timing to implement the load balancing has come (S3111: YES), the file server apparatus 4 determines a method of the load balancing to be implemented (S3112). The determination is made by referring to pre-stored tables. FIG. 32 and FIG. 33 show examples of the tables (hereinafter, referred to as load balancing method determination tables).

Of the tables, a load balancing method determination table 3200 shown in FIG. 32 designates a method of the load balancing (load balancing method 3212) to be implemented for each of identifiers (device name 3211) of the file server apparatus 4. The content of the load balancing method determination table 3200 is set, for example, by a user, operator, or the like.

On the other hand, a load balancing method determination table 3300 shown in FIG. 33 designates a method of the load balancing (load balancing method 3312) to be implemented for each of the dependency ranges (dependency range 3311) of the consolidation file. When determining a method of the load balancing to be implemented on the basis of the load balancing method determination table 3300, the file server apparatus 4 obtains a dependency of de-duplication files allocated thereto and determines a method corresponding to the obtained dependency as a method of the load balancing to be implemented.

Back to FIG. 31, after determining the method of the load balancing to be implemented, the file server apparatus 4 then implements the load balancing in accordance with the determined method. That is, if the determined method is a Method A (S3113: YES), the file server apparatus 4 implements a load balancing processing A (S3400). If the determined method is a Method B (S3114: YES), the file server apparatus 4 implements a load balancing processing B (S3600). If the determined method is a Method C (S3115: YES), the file server apparatus 4 implements a load balancing processing C (S3700). After completion of the processing, the process returns to S3111.

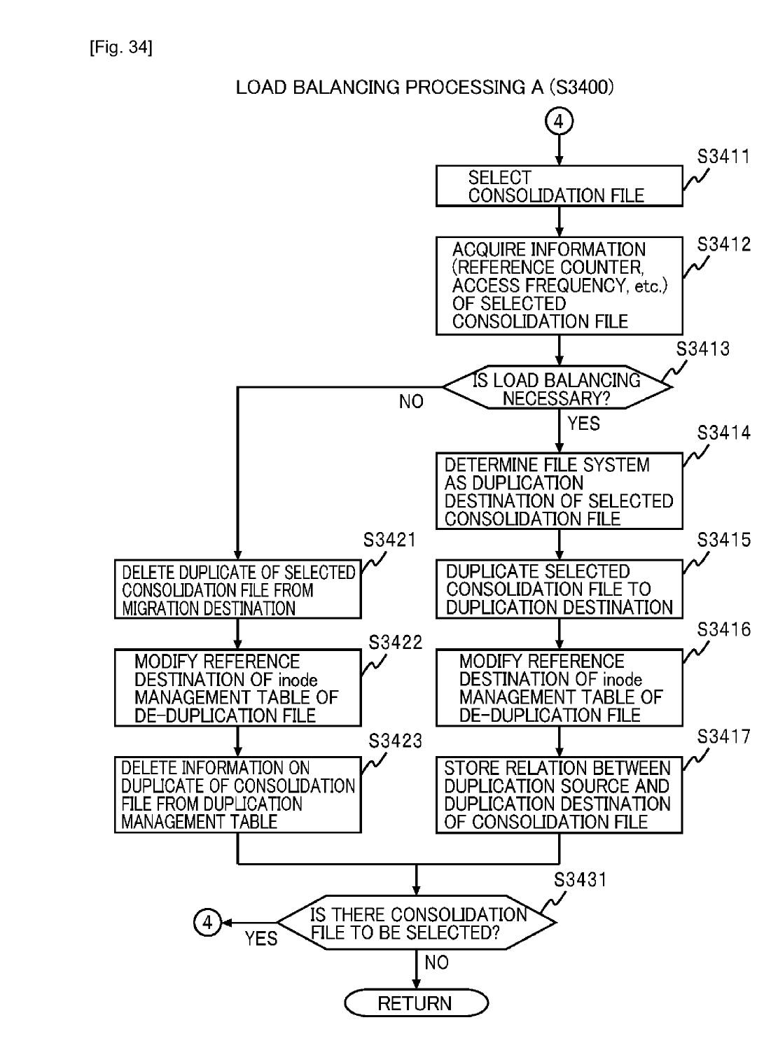

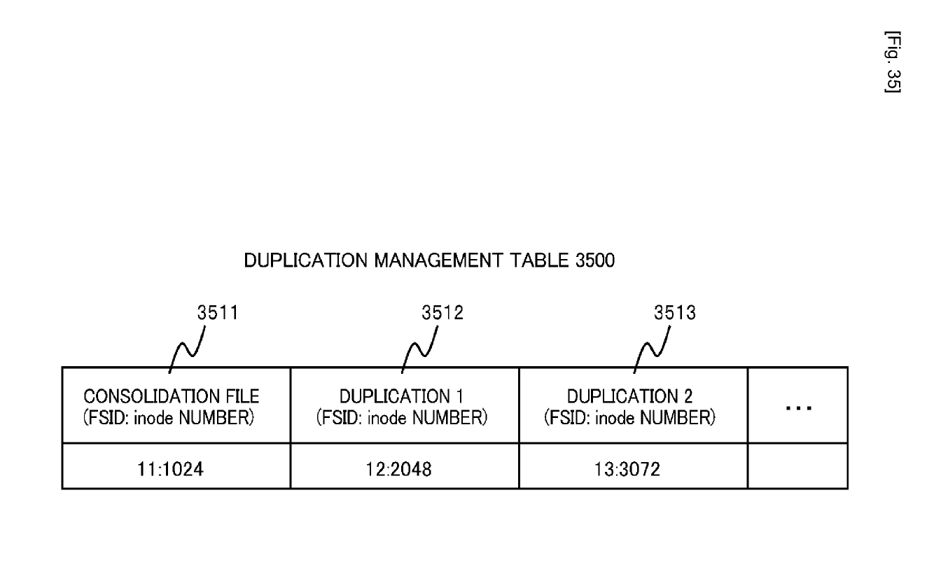

FIG. 34 is a flowchart illustrating the load balancing processing A (S3400). Hereinafter, the load balancing processing A (S3400) is described with reference to FIG. 34.

First, the file server apparatus 4 selects a consolidation file allocated thereto (S3411) and acquires information (the number of de-duplication files referring to the selected consolidation file (hereinafter, referred to as a selected consolidation file), access frequency to the consolidation file, and the like) relating to the selected consolidation file (S3412).

Next, the file server apparatus 4 determines based on the acquired information whether or not the load balancing of the selected consolidation file is necessary (S3413). This determination is made, for example, by checking whether or not the number of de-duplication files referring to the selected consolidation file and access frequency to the selected consolidation file exceed predetermined thresholds. If determined that the load balancing is necessary (S3413: YES), the process proceeds to S3414, and if determined that the load balancing is not necessary (S3413: NO), the process proceeds to S3421.

At S3414, the file server apparatus 4 determines the other file system 413 as a duplication destination of the selected consolidation file. The file server apparatus 4 selects a file system 413 as a duplication destination in such a manner that the load balancing functions efficiently (for example, in such a manner that the consolidation file is allocated evenly to respective file systems 413).

As a method for selecting a file system 413 as a migration destination of the selected consolidation file at this stage, there is, for example, a method which assigns sequential identifiers to respective file systems 413 which are selectable as the duplication destination and selects a file system 413 assigned an identifier corresponding to a remainder obtained by dividing an inode number of the selected consolidation file by a total number of file systems 413, as a duplication destination.

Next, the file server apparatus 4 duplicates the selected consolidation file into a determined duplication destination (S3415) and modifies the content of the inode management table 52 of the consolidation file (consolidation file inode number 561) of de-duplication files referring to the selected consolidation file (S3416). Further, the file server apparatus 4 stores, in a table, a relation between the selected consolidation file and a selected consolidation file duplicated into the duplication destination. Thereafter, the process proceeds to S3431.

FIG. 35 shows an example of the above table (hereinafter, referred to as a duplication management table 3500). As shown in FIG. 35, the duplication management table 3500 manages the relation between information 3511 relating to a consolidation file of the duplication source (a combination of an identifier of a file system 413 to which a consolidation file of the duplication source is allocated, and an inode number of the consolidation file) and information 3512 relating to a consolidation file of the duplication destination (a combination of an identifier of a file system 413 to which a consolidation file of the duplication destination is allocated, and an inode number of the consolidation file).

Back to FIG. 34, at S3421, the file server apparatus 4 determines with reference to the duplication management table 3500 whether or not a duplication of the selected consolidation file exists in another file system 413, and if determined that the duplication exists, the file server apparatus 4 deletes the duplication of the selected consolidation file from the other file system 413. Then, the file server apparatus 4 modifies the content of the inode management table 52 of a consolidation file (consolidation file inode number 561) of de-duplication files referring to the deleted consolidation file (S3422), and deletes the relation between the deleted consolidation file and the selected consolidation file from the duplication management table 3500 (S3423).

At S3431, the file server apparatus 4 determines whether or not another consolidation file to be selected exists. If determined that such a consolidation file exists (S3431: YES), the process returns to S3411. If no other consolidation file exists (S3431: NO), the process returns to S3211 of FIG. 32.

In this way, when the dependencies of de-duplication files are high and thereby access load to a consolidation file is high, the file server apparatus 4 aggressively distributes the consolidated data to different LUs 171 (file system 413), thereby preventing load concentration to a specific LU 171.

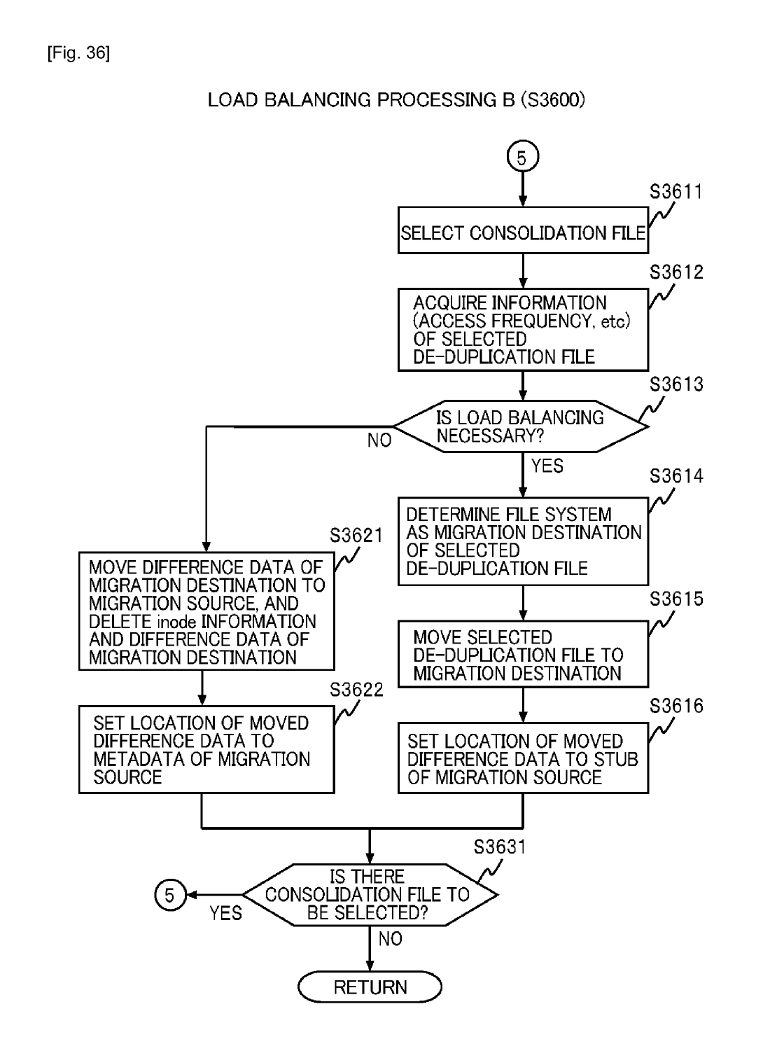

FIG. 36 is a flowchart illustrating the load balancing processing B (S3600). Hereinafter, the load balancing processing B (S3600) is described with reference to FIG. 36.

First, the file server apparatus 4 selects a consolidation file allocated thereto (S3611) and acquires information (such as, access frequency to selected de-duplication files) of de-duplication files referring to the selected consolidation file (hereinafter, referred to as a selected de-duplication file) (S3612).

Next, the file server apparatus 4 determines based on the acquired information whether or not the load balancing of the selected de-duplication file is necessary (S3613). This determination is made, for example, by checking whether or not access frequency to the selected de-duplication file exceeds a predetermined threshold. If determined that the load balancing is necessary (S3613: YES), the process proceeds to S3614, and if determined that the load balancing is not necessary (S3613: NO), the process proceeds to S3621.

At S3614, the file server apparatus 4 determines a file system 413 as a migration destination of the selected de-duplication file (of difference data). The file server apparatus 4 selects a file system 413 as a migration destination of the selected deduplication file in such a manner that the load balancing functions efficiently (for example, in such a manner that the selected de-duplication file is allocated evenly to respective file systems 413).

As a method for selecting a file system 413 as a migration destination of the selected de-duplication file at this stage, there is a method which assigns sequential identifiers to respective file systems 413 which are selectable as the duplication destination and selects a file system 413 assigned an identifier corresponding to a balance obtained by dividing an inode number of the selected de-duplication file by a total number of file systems 413, as a duplication destination.

Next, the file server apparatus 4 generates an inode information of the selected deduplication file at the determined migration destination and moves difference data of the selected de-duplication file to the migration destination (S3615). Further, the file server apparatus 4 sets the location (identifier of the file system 413 of the migration destination, inode number of the migration destination, and the like) of difference data moved to the migration destination to a stub (metadata) of the migration source (S3616). Thereafter, the process proceeds to S3631.

At S3621, the file server apparatus 4 determines with reference to the stub of the migration source whether or not the selected de-duplication file exists in another file system 413. If determined that the selected de-duplication file exists, the file server apparatus 4 moves difference data of the selected de-duplication file from the other file system 413 to the migration source and deletes inode information and difference data of the selected de-duplication file from the other file system 413. Then, the file server apparatus 4 sets the location of difference data moved to the migration source to the metadata of the migration source (S3622).

At S3631, the file server apparatus 4 determines whether or not a consolidation file to be selected exists. If the consolidation file exists (S3631: YES), the process returns to S3611. If no such consolidation file exists (S3631: NO), the process returns to S3211 of FIG. 32.

In this way, when the dependency of de-duplication files is approximately medium and thereby access load to a de-duplication file becomes high, the file server apparatus 4 aggressively distributes difference data to different LUs 171 (file system 413), thereby preventing load concentration to a specific LU 171.

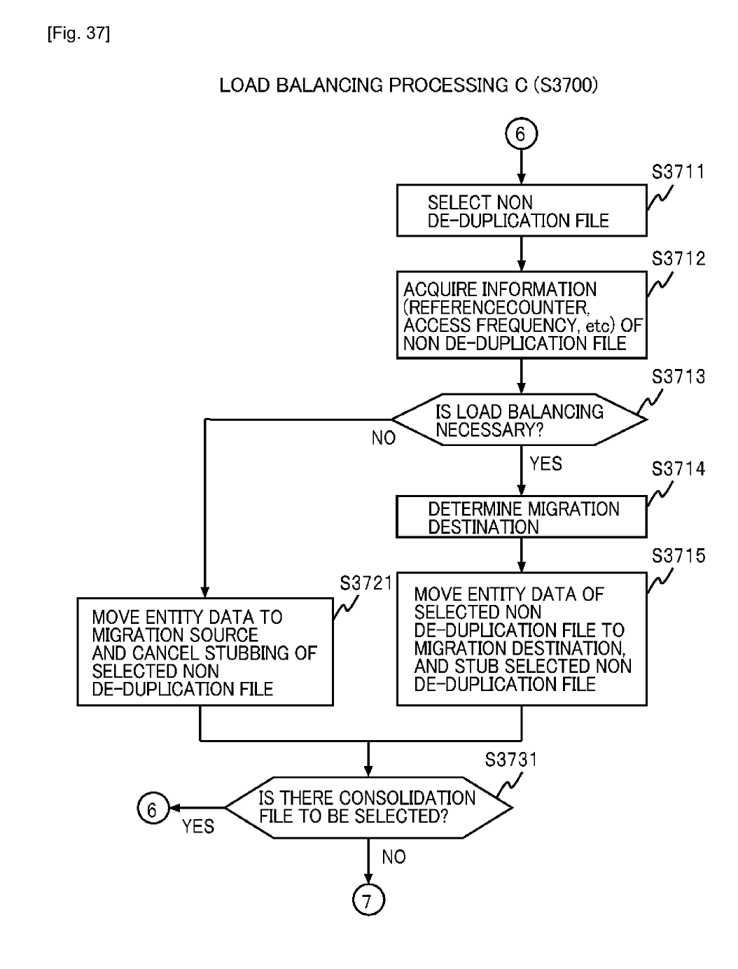

FIG. 37 to FIG. 39 are flowcharts illustrating the load balancing processing C (S3700). Hereinafter, the load balancing process C is described with reference to FIG. 37 to FIG. 39.

As shown in FIG. 37, the file server apparatus 4 firstly selects a non de-duplication file allocated thereto (S3711) and acquires information (such as access frequency to a selected non de-duplication file (hereinafter, referred to as a selected non deduplication file)) of the selected non de-duplication file (S3712).

Next, the file server apparatus 4 determines based on the acquired information whether or not the load balancing of the selected non de-duplication file is necessary (S3713). This determination is made by checking whether or not the access frequency of the selected non de-duplication file exceeds a predetermined threshold. If determined that the load balancing is necessary (S3713: YES), the process proceeds to S3714, and if determined that the load balancing is not necessary (S3713: NO), the process proceeds to S3721.

At S3714, the file server apparatus 4 determines another file system 413 as a migration destination of the selected non de-duplication file. The file server apparatus 4 selects a file system 413 as a migration destination of the selected non de-duplication file in such a manner that the load balancing functions efficiently (for example, in such a manner that the selected non de-duplication file is allocated evenly to respective file systems 413).

As a method for selecting a file system 413 as a migration destination of the selected non de-duplication file, there is such as a method which assigns sequential identifiers to respective file systems 413 which are selectable as the migration destination and selects a file system 413 assigned an identifier corresponding to a remainder obtained by dividing the inode number of the selected non de-duplication file by a total number of file systems 413, as a duplication destination.

Next, the file server apparatus 4 generates inode information of the selected non deduplication file at a determined migration destination, sets the location (identifier of a file system 413 of the migration destination, inode number of the migration destination, and the like) of difference data moved to the migration destination to the metadata (stub) of the migration source, and stubs the selected non de-duplication file by moving entity data of the selected non de-duplication file to the migration destination (S3715). Thereafter, the process proceeds to S3731.

On the other hand, the file server apparatus 4 determines with reference to the stub of the migration source whether or not the selected non de-duplication file exists in other file systems 413. If the non de-duplication file exists, the file server apparatus 4 cancels stubbing of the selected non de-duplication file. Specifically, the file server apparatus 4 moves entity data of the selected non de-duplication file from other file systems 413 to the migration source, deletes inode information and entity data of the selected non de-duplication file from other file systems 413, and sets the location of moved entity data to the metadata of the migration source.

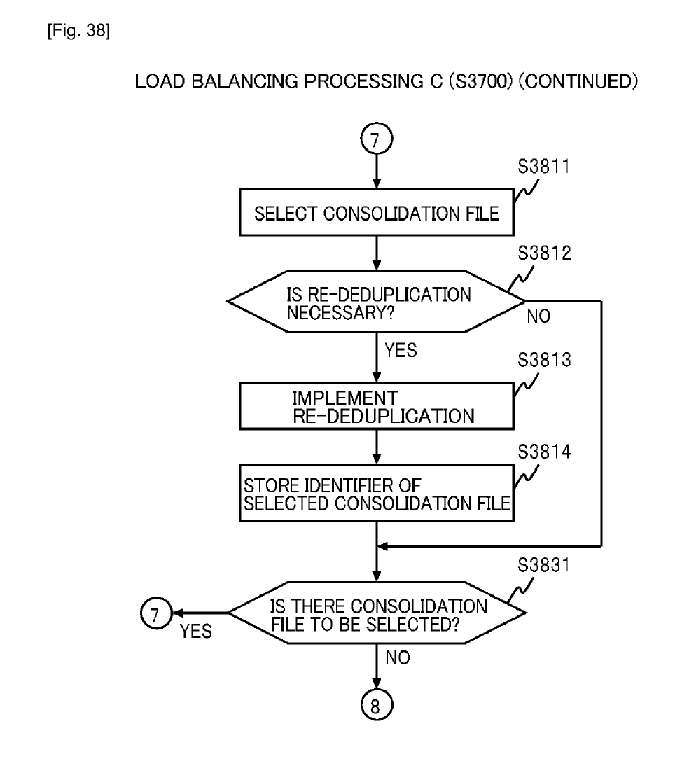

At S3731, the file server apparatus 4 determines whether or not another non deduplication file to be selected exists. If a non de-duplication file exists (S3731: YES), the process returns to S3711, and if not (S3731: NO), the process proceeds to S3811 of FIG. 38.

In this way, when the dependency of de-duplication files is low, the file server apparatus 4 migrates entity data to other file systems 413 by stubbing non deduplication files in a positive manner, thereby preventing load concentration to a specific LU 171 due to concentration of non de-duplication files to the specific LU 171 (file system 413).

At S3811 of FIG. 38, the file server apparatus 4 selects a consolidation file allocated thereto and determines whether or not the re-deduplication of de-duplication files including the selected consolidation file (hereinafter, referred to as a selected consolidation file) by the method described above is necessary. If determined that the re-deduplication of de-duplication files including the selected consolidation file is necessary (S3812: YES), the process proceeds to S3813, and if determined that the re-deduplication is not necessary (S3812: NO), the process proceeds to S3831.

At S3813, the file server apparatus 4 implements the re-deduplication of deduplication files including the selected consolidation file and stores an identifier of the selected consolidation file. The stored identifier of the selected consolidation file is referenced at subsequent processing (such as S3911).

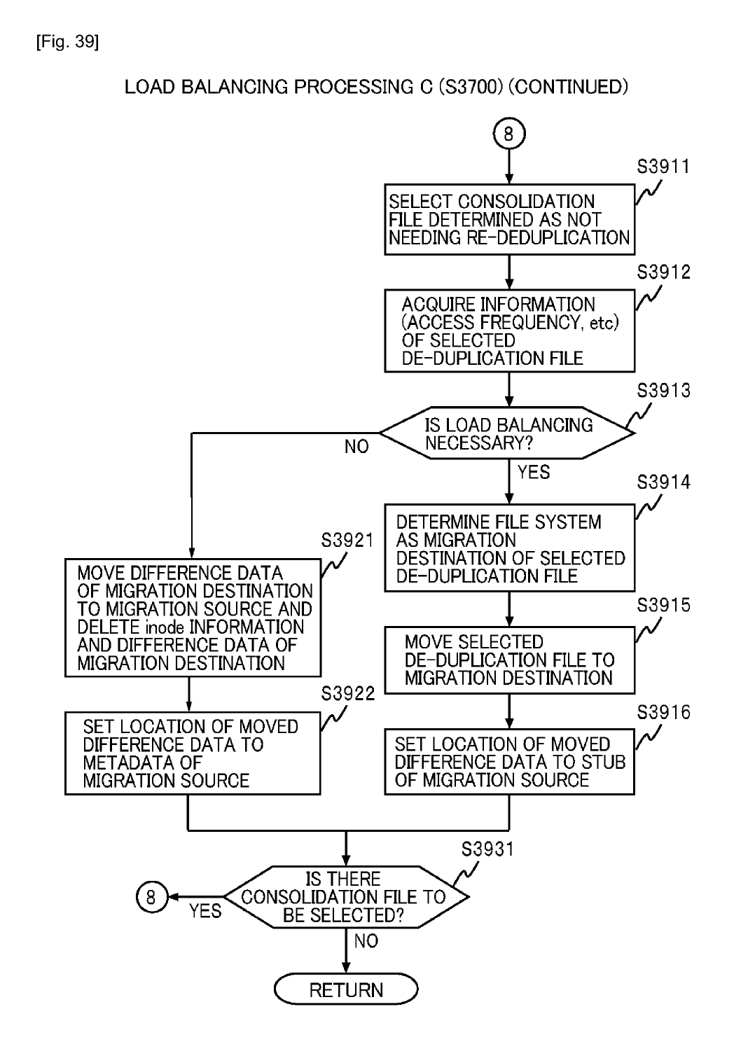

At S3831, the file server apparatus 4 determines whether or not another consolidation file to be selected exists. If such a consolidation file exists (S3831: YES), the process returns to S3811, and if not exist (S3831: NO), the process proceeds to S3911 of FIG. 39.

In this way, when the dependency of de-duplication files is low, the file server apparatus 4 re-extracts common data from de-duplication files and re-organizes (re-deduplicate) the consolidation file and de-duplication files referring thereto, whereby improvements of the dependency and effects of load balancing by application of another load balancing method can be anticipated.

At S3911 of FIG. 39, the file server apparatus 4 selects consolidation files which are determined at S3812 of FIG. 38 that the re-deduplication thereof is not necessary. Next, the file server apparatus 4 acquires information (access frequency of the selected deduplication file, and the like) of a de-duplication file referring to the selected consolidation file (hereinafter, referred to as a selected de-duplication file) (S3912).

Next, the file server apparatus 4 determines based on the acquired information whether or not the load balancing of the selected de-duplication file is necessary (S3913). This determination is made, for example, by checking whether or not access frequency of the selected de-duplication file exceeds a predetermined threshold. If determined that that the load balancing is necessary (S3913: YES), the process proceeds to S3914, if determined that the load balancing is not necessary (S3913: NO), the process proceeds to S3921.

At S3914, the file server apparatus 4 determines another file system 413 as a migration destination of the selected de-duplication file. The file server apparatus 4 selects the file system 413 as a migration destination of the selected de-duplication file (entity data) in such a manner that the load balancing functions efficiently (for example, in such a manner that the selected de-duplication file is allocated evenly to respective file systems 413.)

As a method for selecting a file system 413 as a migration destination of the selected de-duplication file, there is, for example, a method which assigns sequential identifiers to each of file systems which are selectable as a migration destination and selects a file system 413 assigned an identifier corresponding to a remainder obtained by dividing an inode number of the selected de-duplication file by a total number of file systems 413.

Next, the file server apparatus 4 generates an inode number of the selected deduplication file at the determined migration destination, and moves difference data of the selected de-duplication file to the migration destination (S3915). Further, the file server apparatus 4 sets the location (identifier of the file system 413 of the migration destination, inode number of the migration destination, and the like) of the difference data moved to the migration destination to the stub (metadata) of the migration source (S3916). Thereafter, the process proceeds to S3931.

On the other hand, at S3921, the file server apparatus 4 determines with reference to the stub of the migration source whether or not the selected de-duplication file exists in other file systems 413, and if the selected de-duplication file exists, the file server apparatus 4 moves difference data of the selected de-duplication file from the other file system 413 to the migration source, and deletes inode information and difference data of the selected de-duplication file from the other file system 413. Then, the file server apparatus 4 sets the location of the difference data moved to the migration source to metadata of the migration source (S3922).

At S3931, the file server apparatus 4 determines whether or not other consolidation files to be selected (consolidation files of which re-deduplication was determined not necessary at S3812 of FIG. 38) exists. If such a consolidation file exists (S3931: YES), the process returns to S3911, and if not (S3931: NO), the process returns to S3211 of FIG. 32.

In this way, when the dependency of a de-duplication file is low, the file server apparatus 4 migrates difference data of the de-duplication file to other file systems 413 by stubbing the de-duplication file in a positive manner, thereby preventing load concentration to a specific volume due to concentration of de-duplication files thereto.

As described above, whenever a predetermined timing comes, the file server apparatus 4 determines a method of the load balancing based on the dependency of deduplication files, and in accordance with a determined method of the load balancing, distributes at least any one of consolidated data, difference data and non de-duplication file into a plurality of LUs 171. Therefore, data of files can be distributed into a plurality of LUs 171 in accordance with an appropriate method of the load balancing determined based on the dependency when a predetermined timing comes. Thus, when duplicated files are consolidated into a specific file for the purpose of data deduplication, a problem of load concentration to a specific file can be solved permanently, whereby effects of the load balancing can be obtained in a stable manner.

Note that the scheme of load balancing in the file server apparatus 4 described above may be implemented in conjunction with a scheme of distributing group of deduplication files among file server apparatuses 4 described above, or the scheme of the load balancing in the file server apparatus 4 may be implemented independently.

The scheme of load balancing in the file server apparatus 4 described above can further enhance effects of the load balancing by implementing in conjunction with a scheme of the load balancing among logical paths by local path management units 314, 414 described above.

When there is a difference in the performance or specification among LUs 171 to which file data is distributed, the information system 1 can be operated efficiently by appropriately distributing file data in further consideration of both performances and specifications.

The embodiments described above are provided to facilitate understanding of the present invention, but not to construe limitation of the present invention. The present invention may be modified and improved without departing from the spirit thereof and may include equivalents thereto.

1. A file server apparatus configured to process files stored in a plurality of volumes of a storage apparatus in response to an I/O request sent from a client apparatus comprising:
a unit configured to generate, when entity data of a plurality of files has a common portion, a consolidation file that holds common entity data as consolidated data; and
a unit configured to manage each of the plurality of files as a de-duplication file that does not hold the consolidated data, and, when there is the I/O request to at least one of the plurality of files, is configured to acquire the consolidated data and to process in response to the I/O request to at least one of the plurality of files, and to hold difference data generated by performing processing in response to the I/O request including referring to the consolidation file;
wherein a single file system is provided to the client apparatus from volumes among the plurality of volumes,
wherein whenever a predetermined timing comes, the file server apparatus is configured to select a load balancing method according to a dependency obtained, for each of the de-duplication files, the dependency being a ratio of the consolidated data to a sum of the consolidated data and the difference data in a respective of the de-duplication files, the sum being the total size of the respective de-duplication file as seen from a host, to allocate the consolidated data and the difference data based on the dependency, and to distribute at least any one of the consolidated data, the difference data and data of a non de-duplication file into the plurality of volumes in accordance with the selected load balancing method, the non de-duplication file being a file other than the de-duplication files and the consolidation file.

2. The file server apparatus according to claim 1, wherein the load balancing method selected when the dependency is within a predetermined first range is a method of distributing the consolidated data to the plurality of volumes in the case where access load to the consolidation file exceeds a predetermined threshold.

3. The file server apparatus according to claim 2, wherein the load balancing method selected when the dependency is within a predetermined second range narrower than the first range, is a method of distributing the difference data into the plurality of volumes in the case where access load to the de-duplication files exceeds a predetermined threshold.

4. The file server apparatus according to claim 3, wherein the load balancing method selected when the dependency is within a predetermined third range narrower than the second range, is a method of stubbing of the non de-duplication file in the case where access load to the non de-duplication file exceeds a predetermined threshold, the stubbing including leaving metadata of the non de-duplication file in and deleting the entity data thereof from a volume currently storing the non de-duplication file, and allocating the entity data of the non de-duplication file to another volume.

5. The file server apparatus according to claim 3, wherein the load balancing method selected when the dependency is within a predetermined third range narrower than the second range, is a method including, in the case where access load to the non de-duplication file exceeds a predetermined threshold,
re-extracting data common to the de-duplication files referring to the consolidation file,
re-configuring a consolidation file holding the re-extracted data as consolidated data, and
re-configuring each of the de-duplication files as the de-duplication file referring to the generated consolidation file.

6. The file server apparatus according to claim 3, wherein the load balancing method selected when the dependency is within a predetermined third range narrower than the second range, is a method of stubbing the de-duplication files in the case where access load to the de-duplication files exceeds a predetermined threshold, the stubbing including leaving metadata of the de-duplication file in and deleting the difference data thereof from a volume currently storing the de-duplication file, and allocating the difference data of the de-duplication file to another volume.

7. The file server apparatus according to claim 1, wherein
the plurality of volumes are implemented by storage drives included in the storage apparatus, and
the plurality of volumes in each of which at least any one of the consolidated data, the difference data and the data of the non de-duplication file is distributed are implemented by different ones of the storage drives, respectively.

8. The file server apparatus according to claim 1, wherein
the load balancing method selected when the dependency is within a predetermined first range is a method of distributing the consolidated data to the plurality of volumes in the case where access load to the consolidation file exceeds a predetermined threshold;
the load balancing method selected when the dependency is within a predetermined second range narrower than the first range, is a method of distributing the difference data into the plurality of volumes in the case where access load to the de-duplication files exceeds a predetermined threshold;
the load balancing method selected when the dependency is within a predetermined third range narrower than the second range, is a method of stubbing of the non de-duplication file in the case where access load to the non de-duplication file exceeds a predetermined threshold, the stubbing including leaving metadata of the non de-duplication file in and deleting the entity data thereof from a volume currently storing the non de-duplication file, and allocating the entity data of the non de-duplication file to another;
the load balancing method selected when the dependency is within a predetermined third range narrower than the second range, is a method including, in the case where access load to the non de-duplication file exceeds a predetermined threshold, re-extracting data common to the de-duplication files referring to the consolidation file, re-configuring a consolidation file holding the re-extracted data as consolidated data; and re-configuring each of the de-duplication files as the de-duplication file referring to the generated consolidation file;
the load balancing method selected when the dependency is within a predetermined third range narrower than the second range, is a method of stubbing the de-duplication files in the case where access load to the de-duplication files exceeds a predetermined threshold, the stubbing including leaving metadata of the de-duplication file in and deleting the difference data thereof from a volume currently storing the de-duplication file, and allocating the difference data of the de-duplication file to another volume; and
the plurality of volumes are implemented by storage drives included in the storage apparatus, and
the plurality of volumes in each of which at least any one of the consolidated data, the difference data and the data of the non de-duplication file is distributed are implemented by different ones of the storage drives, respectively.

9. An information system including a plurality of file server apparatuses according to claim 1, wherein
the information system is configured to store the dependency range set for each of the file server apparatuses, to determine the dependency of the consolidation file and the de-duplication files allocated to the information system, and to allocate a group of files including the consolidation file and the de-duplication file referring thereto into the file server apparatus associated with the determined dependency.

10. The information system according to claim 9, further including a metadata server apparatus holding metadata of files allocated to each of the file server apparatuses and
upon receiving the I/O request sent from the client apparatus, the metadata server apparatus is configured to return the location of entity data of a target file of the I/O request to the client apparatus, and
each of the file server apparatuses is configured to receive a processing request for the entity data sent from the client apparatus, to perform I/O processing of the file according to the received processing request, and to send a result thereof to the client apparatus.

11. A method for controlling a file server apparatus that processes files stored in a plurality of volumes of a storage apparatus in response to an I/O request sent from a client apparatus, the method comprising:
when entity data of a plurality of files have a common portion, the file server apparatus, generating a consolidation file holding common entity data as consolidated data, and managing each of the plurality of files as a de-duplication file that does not hold the consolidated data, and, when there is the I/O request to at least one of the plurality of files, acquiring the consolidated data, and processing in response to the I/O request to at least one of the plurality of files, and holds difference data generated by performing processing in response to the I/O request including referring to the consolidation file,
wherein a single file system is provided to the client apparatus from volumes among the plurality of volumes, and
whenever a predetermined timing comes, selecting a load balancing method according to a dependency obtained, for each of the de-duplication files, the dependency being a ratio of the consolidated data to a sum of the consolidated data and the difference data in a respective of the de-duplication files, the sum being the total size of the respective de-duplication file as seen from a host, allocating the consolidated data and the difference data based on the dependency, and distributing at least any one of the consolidated data, the difference data and data of a non de-duplication file into the plurality of volumes in accordance with the selected load balancing method, the non de-duplication file being a file other than the de-duplication files and the consolidation file.

12. The method for controlling a file server apparatus according to claim 11, wherein when the dependency is within a predetermined first range, the file server apparatus selecting, as the load balancing method, a method of distributing the consolidated data to the plurality of volumes in the case where access load to the consolidation file exceeds a predetermined threshold.

13. The method for controlling a file server apparatus according to claim 12, wherein when the dependency is within a predetermined second range narrower than the first range, the file server apparatus selecting, as the load balancing method, a method of distributing the difference data into the plurality of volumes in the case where access load to the de-duplication files exceeds a predetermined threshold.

14. The method for controlling a file server apparatus according to claim 13, wherein:
when the dependency is within a predetermined third range narrower than the second range, the file server apparatus selecting, as the load balancing method, a method of stubbing of the non de-duplication file in the case where access load to the non de-duplication file exceeds a predetermined threshold, the stubbing including leaving metadata of the non de-duplication file in and deleting the entity data thereof from a volume currently storing the non de-duplication file, and allocating the entity data of the non de-duplication file to another volume; and
when the dependency is within a predetermined third range narrower than the second range, the file server apparatus selecting, as the load balancing method, a method including: in the case where access load to the non de-duplication file exceeds a predetermined threshold, re-extracting data common to the de-duplication files referring to the consolidation file; re-configuring a consolidation file holding the re-extracted data as consolidated data; and re-configuring each of the de-duplication files as the de-duplication file referring to the generated consolidation file.

15. The method for controlling a file server apparatus according to claim 13, further comprising the step of, when the dependency is within a predetermined third range narrower than the second range, the file server apparatus selecting, as the load balancing method, a method of stubbing the de-duplication files in the case where access load to the de-duplication files exceeds a predetermined threshold, the stubbing including leaving metadata of the de-duplication file in and deleting the difference data thereof from a volume currently storing the de-duplication file, and allocating the difference data of the de-duplication file to another volume.

16. The file server apparatus according to claim 1, wherein respective of the plurality of volumes have different performance.

17. The method for controlling a file server apparatus according to claim 13, wherein respective of the plurality of volumes have different performance.
